(19) United States
(12) Patent Application Publication
(10) Pub. No.: US 2010/0009678 A1
(43) Pub. Date: Jan. 14, 2010

(54) RECOVERY PROCEDURES BETWEEN SUBSCRIBER REGISTERS IN A TELECOMMUNICATION NETWORK

(76) Inventors: Santiago Munoz Munoz, Madrid (ES); Maria Concepcion Garcia Alonso, Majadahonda-Madrid (ES); Daniel Mateos, Madrid (ES)

Correspondence Address: ERICSSON INC., 6300 LEGACY DRIVE, M/S EVR 1-C-11, PLANO, TX, 75024, US

(21) Appl. No.: 12/518,632

(22) PCT Filed: Dec. 12, 2006
(86) PCT No.: PCT/EP2006/069621

§ 371 Date: Jun. 10, 2009

(51) Int. Cl. H04W 8/02

(52) U.S. Cl. 455/433

(57) ABSTRACT

The present invention is aimed to provide subscriber registers of a mobile network with higher performance and memory capacity whilst keeping recovery procedures, such as redundancy and restoration procedures, up to reasonable levels and measurements of network performance, signalling load and response time. The present invention provides for a new clustered architecture for subscriber registers, wherein each subscriber register comprises a number of processing blades, each processing blade handling a reduced number of subscribers, and wherein more processing blades can be added without affecting other components in the subscriber register Failures and unavailability are expected to often occur on a processing blade basis, so that recovery procedures may be carried out for a reduced number of subscribers, thus being completed with lower signalling load and response times. To this end, the present invention also provides for a new method of updating subscriber data between two subscriber registers where at least one follows the clustered architecture.

### TECHNICAL FIELD

The present invention generally relates to enhanced recovery procedures to be carried out between subscriber registers, subscriber databases, or subscriber serving nodes in a telecommunication network. In particular, the invention relates to subscriber registers, subscriber databases, or subscriber serving nodes in a mobile network to allow a faster recovery after failures therein and, more specifically, to minimize the failure situation by detecting partial failures involving only a set of subscribers and by acting on these partial failures.

### BACKGROUND

The high penetration of mobile networks worldwide is now an irrefutable fact and the number of subscribers, as well as the traffic load through the networks, is expected to continue growing as more and more attractive services and achievements are available to users of the mobile networks.

As the number of subscribers grow up for mobile networks, even of a different generation, such as the GSM for a legacy 2^{nd} generation network or the IP Multimedia Subsystem “IMS” under a 3^{rd} generation network, network operators are continuously demanding more performance and memory capacity, whilst maintaining profitability of their business, for those network nodes supporting huge amounts of subscribers and network data.

For instance, a Home Location Register “HLR” in charge of subscriber data, including subscription data, service data and location data for subscribers of a 2^{nd} generation mobile network, and a Visitor Location Register “VLR” holding subscriber data for subscribers roaming in a VLR area of the 2^{nd} generation mobile network, are candidate nodes to be demanded with as high performance and memory capacity as possible to support huge amounts of subscriber data. In particular, the VLR may be provided and considered alone, or in combination with a Mobile Switching Centre “MSC” serving the subscriber and providing, among others, call-related functions. In operation, the VLR receives from the MSC a message indicating a location updating for a subscriber roaming into a VLR area, the message including and identifier of the MSC, and submits towards the HLR a corresponding location updating message, the message now including an identifier of the VLR. The HLR receiving such location updating message, stores the received VLR identifier as location data for the subscriber and returns back to the VLR the own HLR identifier which is stored in the VLR for any further communication. Thus, both HLR having subscriber data for all the subscribers of a mobile network, and VLR having subscriber data for all the subscribers roaming in areas controlled by said VLR, which might be almost all subscribers in crowd population areas, are expected to be provided with even higher performance and memory capacity.

Likewise, a Home Subscriber Server “HSS” holding subscriber data, including subscription, service and location data for subscribers of the IMS in a 3^{rd} generation network, and a Serving Call Session Control Function “S-CSCF”, which is a node assigned for serving the subscriber in the IMS, may be comparable candidate nodes to be demanded with as high performance and memory capacity as possible to support huge amounts of subscriber data. In operation, a subscriber accesses the IMS via a Proxy Call Session Control Function “P-CSCF”, from where a corresponding registration message is submitted towards an Interrogating Call Session Control Function “I-CSCF”. The I-CSCF queries the HSS in order to obtain capabilities required for assigning a serving node for serving the subscriber. Once such capabilities are received from the HSS, the I-CSCF selects and assigns an S-CSCF suitable for serving the subscriber, and submits the registration message towards said S-CSCF. The S-CSCF then submits a message towards the HSS indicating to be assigned for serving the user, the indication including an identifier of said S-CSCF, an obtains from the HSS a user profile, including the subscriber data for the subscriber, along with an identifier of the HSS. Thus, both the HSS having subscriber data for all the subscribers of an IMS network, and the S-CSCF having subscriber data for all the served subscribers in the IMS network, which might still be a significant number of subscribers, are expected to be provided with high performance and memory capacity.

In particular, the location data is traditionally interpreted as an identifier of the S-CSCF serving the subscriber for the HSS in the IMS; as an identifier of the VLR where the subscriber is roaming for the HLR in the 2^{nd} generation mobile network; and as an identifier of the MSC currently serving the subscriber for the VLR in the 2^{nd} generation mobile network.

Apart from the above candidate nodes to be provided with higher performance and capacity: HLR, VLR, HSS, S-CSCF, other network nodes provided for redundancy purposes may be clear candidates as well. For example, a redundant Home Location Register “R-HLR” holding redundant subscriber data for subscribers in one or more primary Home Location Registers of the 2^{nd} generation mobile network, is a network node possibly requiring the highest performance and memory capacity, especially, where configured to serve more than one HLR for redundancy purposes. Generally speaking, a mobile network may be configured with more than one HLR or HSS, as the case may be. In a first configuration, each HLR or HSS may have a first memory portion for primary subscribers handled therein, and a second portion for redundant subscribers handled in another HLR or HSS, so that such network node may be regarded as a primary HLR or HSS for own subscribers and as a R-HLR or R-HSS for redundant subscribers handled in a corresponding primary HLR or HSS. In a second configuration, each primary HLR or HSS includes all its own subscribers and there is provided a corresponding mated node, namely an R-HLR or R-HSS, including redundant data for all the subscribers from the former. In a still third configuration, there is a unique R-HLR or R-HSS handling redundant subscribers from a number of primary HLR's or HS S's as the case may be.

Amongst other recovery procedures in currently existing 2^{nd} or 3^{rd} generation mobile networks, a so-called Redundancy Procedure in HLR or HSS, as the case may be, assumes that a primary HLR or HSS is configured with subscriber data for its own subscribers, whereas an R-HLR or R-HSS is configured with subscriber data for redundant subscribers, which are in fact handled in a primary HLR or HSS. In the following, a redundancy procedure is explained with reference to an HLR of a 2^{nd} generation mobile network whilst it may be applicable as well for those skilled in the art to a 3^{rd} generation mobile network and, more particularly, to an HSS of an IMS network. However, in other implementations the assumption may be that only the primary HLR is configured with subscriber data for the primary subscribers whereas the R-HLR obtains all the redundant subscriber data once entering into normal operation.

In general and during normal operation, traffic messages are routed by the network to the HLR where a given subscriber is defined as primary. However, each HLR may accept operations from the network for any subscriber defined therein. Where a non-permanent subscriber data is changed in the primary HLR in charge of corresponding subscriber, as a consequence of any subscriber activities such as a change in the subscriber location data, said data change is sent from the primary HLR towards the R-HLR, wherein the changed non-permanent subscriber data is updated. In a situation where the primary HLR fails, or becomes unavailable to the network, the R-HLR starts handling traffic for all subscribers in the failing primary HLR. Afterwards, once the failing primary HLR has recovered from the failure and resumes work, the non-permanent subscriber data for a huge number of subscribers may be not up-to-date since, depending on how long the failure lasts, a huge amount of subscriber activities took place with corresponding changes on subscriber data. To this end, the recovering primary HLR keeps disconnected from the network until having been updated with information up-to-date from the R-HLR. Once updated, the primary HLR may enter into operation and the R-HLR disconnected from the network.

This so-called Redundancy Procedure, as other recovery procedures in currently existing 2^{nd} or 3^{rd} generation mobile networks, becomes a quite overloading procedure where demands are put by network operators to provide network nodes supporting huge amounts of subscribers and subscriber data and thus presenting a higher performance and memory capacity, whilst maintaining low prices. More specifically, the provision of network nodes such as HLR, VLR, HSS, S-CSCF, and R-HLR with higher performance and memory capacity represents a challenging drawback for suppliers wanting to keep the overall network performance, signalling load and response times up to reasonable levels and measurements.

Apart from the so-called Redundancy Procedure explained above, other recovery procedures such as a Restoration procedure between an HLR and a VLR of a 2^{nd} generation mobile network may also penalize the overall network performance, signalling load and response times up to reasonable levels and measurements.

Where a HLR in a 2^{nd} generation mobile network, or a HSS in an IMS network, has recovered from a failure situation and comprises subscriber data which can not be considered up-to-date for a substantial number subscribers, and with or without support of the above Redundancy procedure, such HLR or HSS requires the updating of most significant subscriber data for all the subscribers as there is no clue of what subscriber data may be trustable or not, and for what subscribers. In this respect, the subscriber location data is one among the most significant subscriber data for this purpose and may be wrong where addressing a previous serving node, namely a previous MSC, VLR or S-CSCF, not currently serving the subscriber due to a newer roaming area involving a different MSC or VLR, or a re-assignation of a new S-CSCF to handle service capabilities not supported by the previous S-CSCF and required for a new service invoked by the subscriber. In the following, a restoration procedure is explained with reference to an HLR of a 2^{nd} generation mobile network whilst it may be applicable as well for those skilled in the art to a 3^{rd} generation mobile network and, more particularly, to an HSS of an IMS network.

A so-called restoration procedure may start once a failing HLR has recovered from a failure and resumes work, and non-permanent subscriber data, such as the location data, for a huge number of subscribers may be not up-to-date. Such recovered HLR, following a ‘best effort’ approach, sends a reset indication towards all the known VLR's where own subscribers are marked to be roaming. Those VLR's receiving such reset indication, which includes an identifier of the HLR having recovered from a failure, search for subscribers marked with said HLR identifier and disconnect such subscribers by withdrawing them from the VLR areas where they are roaming in order to force a new location updating that allows the recovered HLR to get appropriate location data for such subscribers.

As for the redundancy procedure and other recovery procedures, the restoration procedure becomes a quite overloading procedure where demands are put by network operators to provide network nodes supporting huge amounts of subscribers and subscriber data and thus presenting a higher performance and memory capacity, whilst maintaining low prices. In view of this so-called restoration procedure, the provision of network nodes such as HLR, VLR, HSS, S-CSCF, and R-HLR with higher performance and memory capacity represents a challenging drawback for suppliers wanting to keep the overall network performance, signalling load and response times up to reasonable levels and measurements.

### SUMMARY

It is an object of the invention to obviate or, at least, minimize some of the above drawbacks, and to provide network nodes for mobile network operators, such as HLR, VLR, HSS, S-CSCF, and R-HLR with higher performance and memory capacity whilst still keeping the overall network performance, signalling load and response times up to reasonable levels and measurements.

To this end, there is provided in accordance with a first aspect of the invention a clustered subscriber register for holding subscriber data for subscribers in a mobile network, wherein the subscriber data comprise subscription data as well as location data for each subscriber. This clustered subscriber register includes:
an input unit arranged for receiving location data for a subscriber from a serving node in the mobile network;
a plurality of processing blades, each processing blade handling a number of subscribers and comprising: a storage arranged for storing subscriber data for the subscriber, and a processor arranged for processing a course of actions to be taken for the subscriber depending on subscriber data for the subscriber;
a distributor for determining the processing blade currently handling the subscriber; and
an output unit arranged for submitting a subscriber identity for the subscriber, an identifier of the clustered subscriber register, and an identifier of the processing blade handling the subscriber towards a secondary subscriber register in the mobile network.

This clustered architecture for a subscriber register, wherein each processing blade is in charge of a number of subscribers, allows for a profitable scalability where more processing blades can be added without substantially affecting the rest of components in the clustered subscriber register. In addition, failures and unavailability are expected to more frequently occur on a processing blade basis, rather than for the whole clustered subscriber register, so that proper actions can be taken for one or a reduced number of processing blades, instead of for the whole clustered subscriber register. Bearing in mind that each processing blade just handles a number of subscribers, the recovery procedures can be carried out for an expectedly smaller number of subscribers, thus being completed with lower signalling load and response times.

In particular, this clustered subscriber register may be useable as a VLR and, in such a case, the input unit is arranged for receiving the location data for the subscriber from an MSC currently serving the subscriber, whereas the output unit is arranged for submitting towards a HLR the subscriber identity for the subscriber, the identifier of the VLR and the identifier of the processing blade handling the subscriber therein. In other words, the clustered subscriber register may act as a VLR receiving location data from the MSC, and submitting its own VLR identifier and its processing blade identifier as location data for the subscriber towards the secondary subscriber register, that is, towards the HLR. Regarding the HLR, it may be a non-clustered HLR behaving as a secondary subscriber register adapted to inter-work with a clustered VLR, or it may be a clustered HLR behaving in accordance with this clustered subscriber register as well.

This clustered subscriber register may be implemented in accordance with embodiments of the invention so that the output unit is further arranged for submitting a set of subscriber data along with the subscriber identity for the subscriber, the identifier of the clustered subscriber register and the identifier of the processing blade, towards the secondary subscriber register in the mobile network. This is particularly interesting for using this clustered subscriber register as a HLR of a 2^{nd} generation mobile network and, in such a case, the input unit is arranged for receiving location data for the subscriber from a VLR currently serving the subscriber; as well as for using this clustered subscriber register as a HSS of an IMS in a 3^{rd} generation mobile network and, in such a case, the input unit is arranged for receiving location data for the subscriber from a S-CSCF currently assigned for serving the subscriber.

Where the clustered subscriber register acts as a HLR, the output unit may be arranged for submitting towards an R-HLR, which behaves as the secondary subscriber register for redundancy purposes, the subscriber identity and the set of subscriber data for the subscriber, the identifier of the HLR and the identifier of the processing blade handling the subscriber in said HLR. This clustered subscriber register acting as a HLR towards a secondary subscriber register acting as a R-HLR may further comprise a replicator for coordinating with the R-HLR a redundancy procedure for sending subscriber data for those subscribers handled in a processing blade identified by a given identifier. Moreover, the replicator may further comprise a state-transition machine operating on a processing blade basis to determine the status of the redundancy procedure on course for each processing blade thus helping to keep the overall network performance, signalling load and response times up to reasonable levels and measurements where recovery procedures can be carried out on a processing blade basis.

Where the clustered subscriber register acts as a HLR, the output unit may be arranged as well for submitting towards a VLR, which behaves as the secondary subscriber register for holding subscriber data for subscribers roaming in a VLR area of the mobile network, the subscriber identity and the set of subscriber data for the subscriber, the identifier of the HLR and the identifier of the processing blade handling the subscriber in said HLR. This clustered subscriber register, acting as a HLR towards a secondary subscriber register acting as a VLR, may further comprise a restorer arranged for submitting, after having recovered from a failure affecting a processing blade, a reset indication towards those VLRs holding subscriber data for those subscribers handled by the recovered blade, the reset indication including the identifier of the clustered subscriber register and the identifier of the recovered processing blade. This more selective reset allows a faster restoration procedure thus helping to keep the overall network performance, signalling load and response times up to reasonable levels and measurements where recovery procedures can be carried out on a processing blade basis.

Where the clustered subscriber register acts as a HSS, the output unit may be arranged for submitting towards the S-CSCF, which behaves as the secondary subscriber register for serving the subscriber in the IMS, the subscriber identity and the set of subscriber data for the subscriber, the identifier of the Home Subscriber Server and the identifier of the processing blade handling the subscriber. This clustered subscriber register, acting as a HSS towards a secondary subscriber register acting as a S-CSCF, may also further comprise a restorer arranged for submitting, after having recovered from a failure affecting a processing blade, a reset indication towards those S-CSCFs holding subscriber data for those subscribers handled by the recovered blade, the reset indication including the identifier of the clustered subscriber register and the identifier of the recovered processing blade.

Furthermore, the clustered subscriber register, whatever use is given, may be implemented so that the input unit is arranged for receiving any upgraded operation to process a course of actions for the subscriber, wherein this upgraded operation includes the subscriber identity for the subscriber and the identifier of the processing blade handling the subscriber.

In accordance with a second aspect of the invention, there is provided a secondary subscriber register inter-working with the above clustered subscriber register for holding subscriber data for subscribers in the mobile network, the subscriber data comprising subscription data and location data for each subscriber. This secondary subscriber register comprises:
an input unit arranged for receiving from the clustered subscriber register, which holds subscriber data for a subscriber in the mobile network, a subscriber identity for the subscriber, an identifier of the clustered subscriber register, and an identifier of a processing blade handling the subscriber at the clustered subscriber register;
a storage arranged for storing subscriber data and the subscriber identity for the subscriber, the identifier of the clustered subscriber register and the identifier of the processing blade for the subscriber therein; and
a processor arranged for processing a course of actions to be taken for the subscriber depending on the received subscriber data.

This secondary subscriber register may further comprise an output unit arranged for submitting towards the clustered subscriber register any upgraded operation to process a course of actions for the subscriber, wherein each upgraded operation includes the subscriber identity for the subscriber and the identifier of the processing blade handling the subscriber at the clustered subscriber register.

In particular, where the above clustered subscriber register may be useable as a VLR, this secondary subscriber register may be useable as a HLR and, in such a case, the input unit is arranged for receiving from the VLR the subscriber identity for the subscriber, the identifier of the VLR, and the identifier of the processing blade handling the subscriber as location data for said subscriber.

This secondary subscriber register may be implemented in accordance with embodiments of the invention so that the input unit is arranged for receiving a set of subscriber data for the subscriber, along with the subscriber identity for the subscriber, the identifier of the clustered subscriber register and the identifier of the processing blade, from the clustered subscriber register in the mobile network. Aligned with corresponding embodiments for the clustered subscriber register, this input unit arranged for receiving a set of subscriber data for the subscriber is particularly interesting for using this secondary subscriber register as an R-HLR, as a VLR, or as an S-CSCF.

Where this secondary subscriber register is acting as an R-HLR, the input unit is arranged for receiving from a clustered HLR the subscriber identity and the set of subscriber data for the subscriber, the identifier of said HLR and the identifier of the processing blade handling the subscriber at said HLR. This secondary subscriber register acting as an R-HLR may further comprise a replicator for coordinating with the clustered HLR a redundancy procedure for receiving subscriber data for those subscribers handled in a processing blade identified by a given identifier. Moreover, this replicator may further comprise a state-transition machine operating on a processing blade basis to determine the status of the redundancy procedure on course for each processing blade thus helping to keep the overall network performance, signalling load and response times up to reasonable levels and measurements where recovery procedures can be carried out on a processing blade basis by coordinated clustered and secondary subscriber registers provided in accordance with several aspects of the invention

Where this secondary subscriber register is acting as a VLR, the input unit is arranged for receiving from a clustered HLR the subscriber identity and the set of subscriber data for the subscriber, the identifier of said HLR and the identifier of the processing blade handling the subscriber at said HLR. Moreover, this secondary subscriber register acting as a VLR further comprises an output unit arranged for submitting location data for the subscriber towards the clustered HLR, this location data comprising an identifier of the subscriber and an identifier of the VLR. Furthermore, this secondary subscriber register acting as a VLR may further comprise a restorer arranged for receiving a reset indication from the clustered HLR, the reset indication including the identifier of the clustered HLR and an identifier of a processing blade recovered after failure. Still further, the restorer may be arranged for initiating a restoration procedure for all the subscribers with the received identifier of the processing blade in this secondary subscriber register acting as a VLR.

Where this secondary subscriber register is acting as an S-CSCF, the input unit is arranged for receiving from a clustered HSS the subscriber identity and the set of subscriber data for the subscriber preferably in the form of a user profile, the identifier of said HSS and the identifier of the processing blade handling the subscriber at said HSS. Moreover, this secondary subscriber register acting as an S-CSCF further comprises an output unit arranged for submitting location data for the subscriber towards the clustered HSS, this location data comprising an identifier of the subscriber and an identifier of the S-CSCF. Furthermore, this secondary subscriber register acting as an S-CSCF may further comprise a restorer arranged for receiving a reset indication from the clustered HSS, the reset indication including the identifier of the clustered HSS and an identifier of a processing blade recovered after failure. Still further, the restorer may be arranged for initiating a restoration procedure for all the subscribers with the received identifier of the processing blade in this secondary subscriber register acting as an S-CSCF.

The above clustered subscriber register may be thus used in cooperation with the above secondary register so that the clustered subscriber register incorporates a number of processing blades and provides an identifier of the processing blade handling a given subscriber, whereas the secondary subscriber register is arranged for receiving this identifier of a processing blade handling the given subscriber, and is arranged for applying recovery procedures on a processing blade basis.

These clustered and secondary subscriber registers are enabled in accordance with a third aspect of the invention to carry out a method of updating subscriber data between said clustered subscriber register and said secondary subscriber register, both holding subscriber data for subscribers in a mobile network, the subscriber data comprising subscription data and location data. This method comprises the steps of:
receiving at the clustered subscriber register location data for a subscriber from a serving node in the mobile network;
determining at a distributor of the clustered subscriber register a processing blade currently handling the subscriber, among a plurality of processing blades, each processing blade handling a number of subscribers and including a storage and a processor;
processing at the processor included in the processing blade a course of actions to be taken for the subscriber depending on the subscriber data; and
submitting from the clustered subscriber register towards the secondary subscriber register a subscriber identity for the subscriber, an identifier of the clustered subscriber register, and an identifier of the processing blade handling the subscriber at the clustered subscriber register.

In a first embodiment of the invention, the step of receiving location data for the subscriber and the step of submitting identifiers in this method may take place in a clustered subscriber register acting as a VLR. In this embodiment, an MSC is the serving node where the location data is received from, whereas a HLR is the secondary subscriber register where the subscriber identity for the subscriber, the identifier of the VLR and the identifier of the processing blade are submitted to.

The above method is particularly advantageous where the step of submitting the subscriber identity, the identifier of the clustered subscriber register, and the identifier of the processing blade from the clustered subscriber register towards the secondary subscriber register includes a step of obtaining from the storage included in the processing blade a set of subscriber data for the subscriber, and a step of submitting the set of subscriber data for the subscriber.

In a second embodiment of the invention, the step of receiving location data for the subscriber and the step of submitting the subscriber identity and the set of subscriber data for the subscriber, the identifier of the clustered subscriber register, and the identifier of the processing blade in this method may take place in a clustered subscriber register acting as a HLR. In this second embodiment, a VLR is the serving node where the location data is received from, whereas an R-HLR is the secondary subscriber register where the subscriber identity and the set of subscriber data for the subscriber, the identifier of the HLR and the identifier of the processing blade are submitted to. Moreover, the method may further comprise for this second embodiment a step of coordinating between the HLR and the R-HLR a redundancy procedure for sending subscriber data for those subscribers handled in a processing blade identified by a given identifier. Furthermore, in order to determine the status of the redundancy procedure on course for each processing blade, the method may also comprise a step of operating a state-transition machine on a processing blade basis.

In a third embodiment of the invention, the step of receiving location data for the subscriber and the step of submitting the subscriber identity and the set of subscriber data for the subscriber, the identifier of the clustered subscriber register, and the identifier of the processing blade in this method may take place in a clustered subscriber register acting as a HLR. In this third embodiment, a VLR is also the serving node where the location data is received from, whereas said VLR is the secondary subscriber register where the subscriber identity and the set of subscriber data for the subscriber, the identifier of the HLR and the identifier of the processing blade are submitted to. Moreover, the method may further comprise for this third embodiment a step of submitting, after having recovered from a failure affecting a processing blade, a reset indication from the HLR towards those VLRs holding subscriber data for those subscribers handled by the recovered blade, the reset indication including the identifier of the HLR and the identifier of the recovered processing blade.

In a fourth embodiment of the invention, the step of receiving location data for the subscriber and the step of submitting the subscriber identity and the set of subscriber data for the subscriber, the identifier of the clustered subscriber register, and the identifier of the processing blade in this method may take place in a clustered subscriber register acting as a HSS. In this fourth embodiment, an S-CSCF is the serving node where the location data is received from, whereas said S-CSCF is the secondary subscriber register where the subscriber identity and the set of subscriber data for the subscriber, the identifier of the HSS and the identifier of the processing blade are submitted to. As for the above third embodiment, the method may further comprise for this fourth embodiment a step of submitting, after having recovered from a failure affecting a processing blade, a reset indication from the HSS towards those S-CSCF holding subscriber data for those subscribers handled by the recovered blade, the reset indication including the identifier of the HSS and the identifier of the recovered processing blade.

Commonly applicable to the above embodiments, the method may further comprise a step of receiving any upgraded operation to process a course of actions for the subscriber, wherein the upgraded operation includes the subscriber identity for the subscriber and the identifier of the processing blade handling the subscriber in order to more efficiently reach subscriber data and identify actions to be done for said subscriber.

In accordance with a fourth aspect of the invention, there is provided a computer program, loadable into an internal memory of a computer with input and output units as well as with a processing unit, the computer program comprising executable software adapted to carry out at least some of the above method steps when running in the computer. In particular, the executable software of this computer program may be recorded in a carrier readable in a computer.

### BRIEF DESCRIPTION OF THE DRAWINGS

The features, objects and advantages of the invention will become apparent by reading this description in conjunction with the accompanying drawings, in which:

FIG. 1 is a sequence diagram illustrating an embodiment of a method for updating the subscriber location between a Visitor Location Register and a Home Location Register, wherein the Home Location Register is a clustered subscriber register in accordance with the invention.

FIG. 2 is a sequence diagram illustrating a method of restoration from the Home Location Register towards a plurality of Visitor Location Registers known to said Home Location Register, in accordance with an embodiment of the invention.

FIG. 3 is a sequence diagram illustrating an embodiment of a method for updating the subscriber location between a Mobile Switching Centre and a Visitor Location Register and between the Visitor Location Register and a Home Location Register, wherein the Visitor Location Register is a clustered subscriber register in accordance with the invention.

FIG. 4 is a basic block structure presenting the structural elements that a clustered subscriber register comprises in accordance with an embodiment of the invention where acting as a Home Location Register.

FIG. 5 is a basic block diagram illustrating a scenario where clustered and subscriber registers as well as method of the invention may be applied in a 2^{nd} generation mobile network.

FIG. 6 is a basic block diagram illustrating a scenario where clustered and subscriber registers as well as method of the invention may be applied for an IMS in a 3^{rd} generation mobile network.

FIG. 7 is a basic block structure presenting the structural elements that a clustered subscriber register comprises in accordance with an embodiment of the invention where acting as a Visitor Location Register.

FIG. 8 is a sequence diagram illustrating an embodiment of a method for registering a subscriber in an IMS network, said method including a method of updating the subscriber location between a Serving Call Session Control Function and a Home Subscriber Server, wherein the Home Subscriber Server is a clustered subscriber register in accordance with the invention.

FIG. 9 is a basic block structure presenting the structural elements that a clustered subscriber register comprises in accordance with an embodiment of the invention where acting as a Home Subscriber Server.

FIG. 10 is a basic block structure presenting the structural elements that a secondary subscriber register comprises in accordance with several embodiments of the invention where acting as a Visitor Location Register, as a Home Subscriber Server, as a Serving Call Session Control Function, as a Home Subscriber Server, or as a redundant Home Location Register.

FIG. 11a-11d is a sequence diagram illustrating an embodiment of a method for carrying out a redundancy procedure between a clustered subscriber register acting as a Home Location Register and a secondary subscriber register acting as a redundant Home Location Register, the method showing how a replica of non-permanent subscriber data is created in the redundant Home Location Register whilst the primary Home Location Register is active, how the redundant Home Location Register handles subscribers whilst a partial failure occurs in the primary Home Location Register, and how the primary Home Location Register becomes active after recovering from the partial failure, and once a replica of changed non-permanent subscriber data is created in the primary Home Location Register from the redundant Home Location Register.

### DETAILED DESCRIPTION

The following describes some preferred embodiments for a method of updating subscriber data between a clustered subscriber register and a secondary subscriber register, both holding subscriber data for subscribers in a mobile network, wherein the subscriber data comprises subscription data and location data. Apart from this method, the following describes exemplary embodiments of said clustered subscriber register and said secondary subscriber register in terms of its respective structural elements to carry out said method.

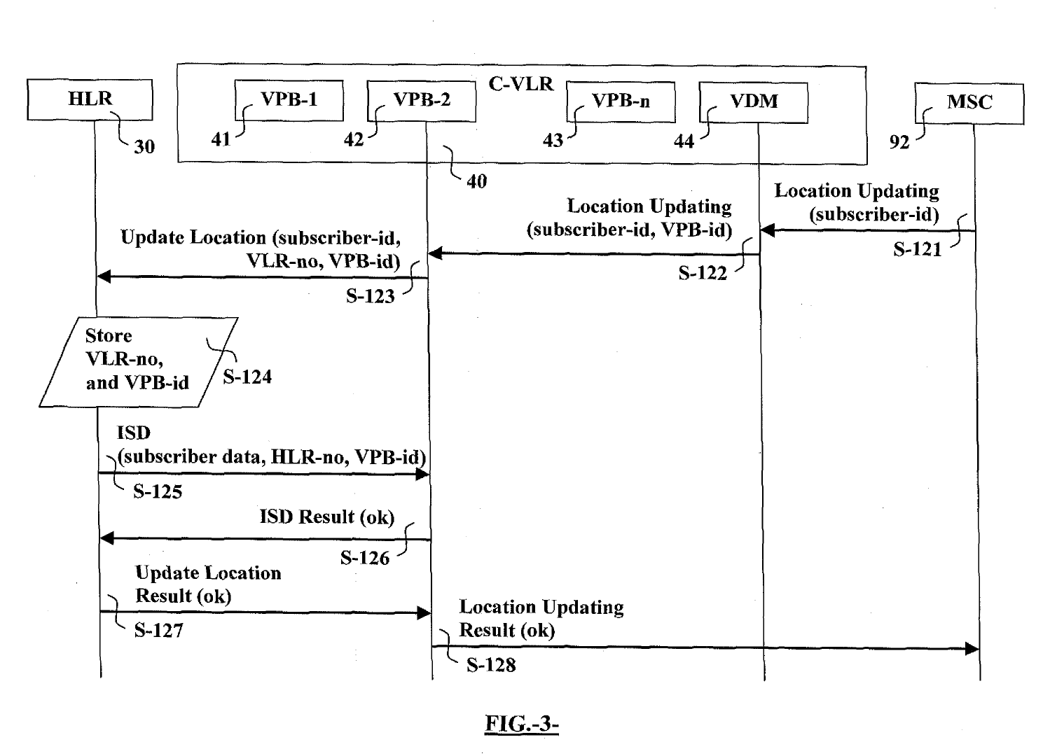

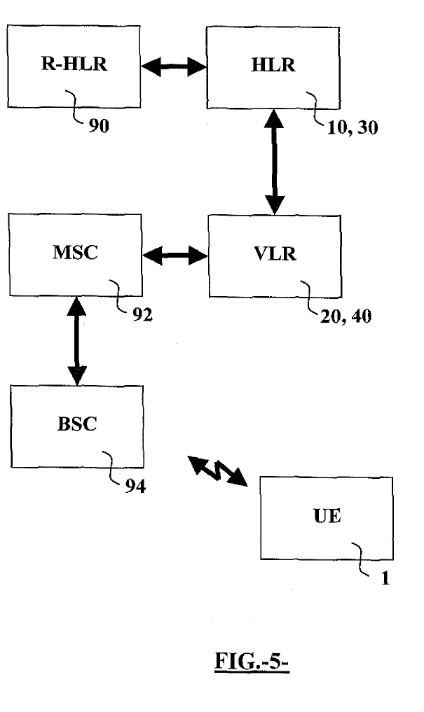

In a first embodiment of the invention illustrated in FIG. 3 there is provided a method of updating subscriber data between a clustered subscriber register 40 acting as a VLR, namely a clustered VLR “C-VLR”, and a secondary subscriber register acting as a HLR. This method may preferably apply in a scenario as basically illustrated in FIG. 5 wherein a subscriber 1 attaches via a radio interface a 2^{nd} generation mobile network through a base station not shown for the sake of simplicity, and reaches a Base Station Centre “BSC” 94 connected with an MSC 92 receiving the subscriber attach.

This method illustrated in FIG. 3 starts with a step S-121 of receiving at the clustered VLR (C-VLR) 40 location data for the subscriber 1 from the MSC 92, which is the serving node currently serving the subscriber in the mobile network.

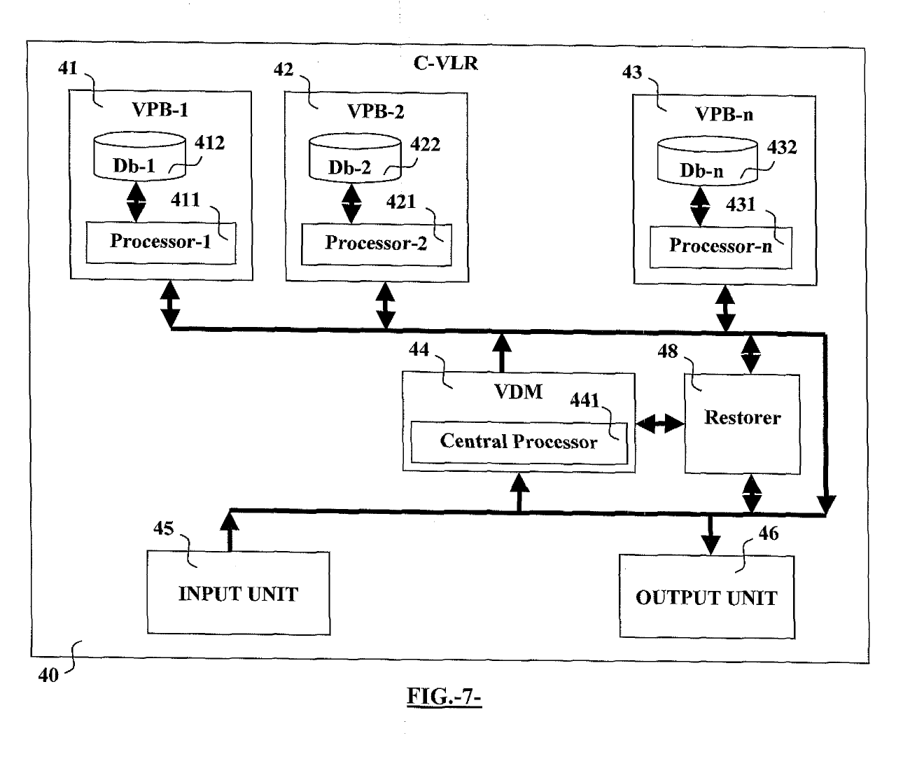

To this end, as illustrated in FIG. 7, the C-VLR 40 includes an input unit 45 arranged for receiving said location data for the subscriber from the MSC 92 in the mobile network. Since this C-VLR comprises a plurality of processing blades 41-43, a particular processing blade 42 must be determined for handling this subscriber. This particular processing blade 42, as each processing blade 41-43, handles a number of subscribers and comprises: a storage 422 arranged for storing subscriber data for the subscriber 1, and a processor 421 arranged for processing a course of actions to be taken for the subscriber depending on subscriber data for said subscriber. To this end, the C-VLR 40 includes a distributor 44, the so-called visitor distribution module “VDM” in this instant specification, for determining the processing blade 42 currently handling the subscriber. In particular, this distributor may include a central processor 441 for carrying out common routines for all the processing blades as well as for controlling the availability status for each processing blade. Then, the input unit 45 internally passes a location updating message received with location data for the subscriber to the distributor 44, which is the internal entity receiving the location data during this step S-121.

The sequence of actions illustrated in FIG. 3 thus continues with a step S-122 of determining at the distributor 44 of the C-VLR the processing blade 42 for handling the subscriber, and internally passing the location updating message received with location data for the subscriber to said processing blade 42. Then, the processing blade receiving such location updating message, processes and stores the new location, namely an identifier of the MSC 92 currently serving the subscriber, and submits in step S-123 towards the secondary subscriber register 30, which in the present embodiment is a HLR holding subscriber data for subscribers of the mobile network, a subscriber identity for the subscriber, an identifier of the C-VLR, and an identifier of the processing blade handling the subscriber at the C-VLR.

To this end, as illustrated in FIG. 7, the C-VLR, comprises an output unit 46 an output unit arranged for submitting the subscriber identity for the subscriber, the identifier of the C-VLR, and the identifier of the processing blade handling the subscriber towards a secondary subscriber register, in this case the HLR, in the mobile network.

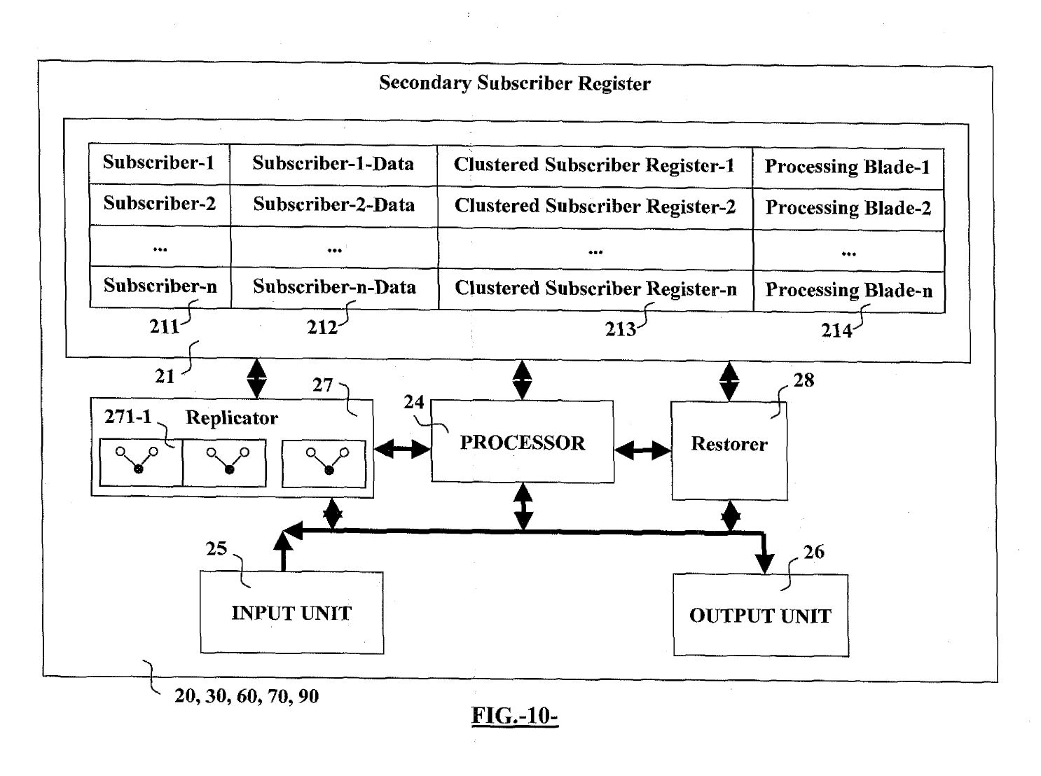

On the other hand, the secondary subscriber register 30 illustrated in FIG. 10, which in this first embodiment is a HLR of a 2^{nd} mobile network, comprises an input unit 25 arranged for receiving from the C-VLR the subscriber identity for the subscriber, the identifier of the C-VLR, and the identifier of the processing blade handling the subscriber at the C-VLR; a storage 21 arranged for storing the subscriber data 212 and the subscriber identity 211 for the subscriber, the identifier 213 of C-VLR and the identifier 214 of the processing blade for the subscriber therein; and a processor 24 arranged for processing a course of actions to be taken for the subscriber depending on the received subscriber data. In particular, the method described in this first embodiment may further include a step S-124 of storing at the HLR the location data, namely the identifier of the C-VLR 40 and the identifier of the processing blade 42, for the subscriber.

This method allows any further action triggered for this subscriber 1 towards the C-VLR to include the identifier of the processing blade in order to more efficiently reach subscriber data and identify actions to be done for said subscriber. For example, the method described in this first embodiment may further include a step S-125 of submitting from the HLR towards the C-VLR a set of subscriber data for the subscriber along with an identifier of the HLR and the identifier of the processing blade 42 handling the subscriber in the C-VLR. To this end, the secondary subscriber register acting as the HLR 30 also comprises an output unit 26 arranged for submitting towards the clustered subscriber register, which is now the C-VLR 40, an upgraded operation to process a course of actions for the subscriber, wherein each upgraded operation includes the subscriber identity for the subscriber and the identifier of the processing blade handling the subscriber at the clustered subscriber register.

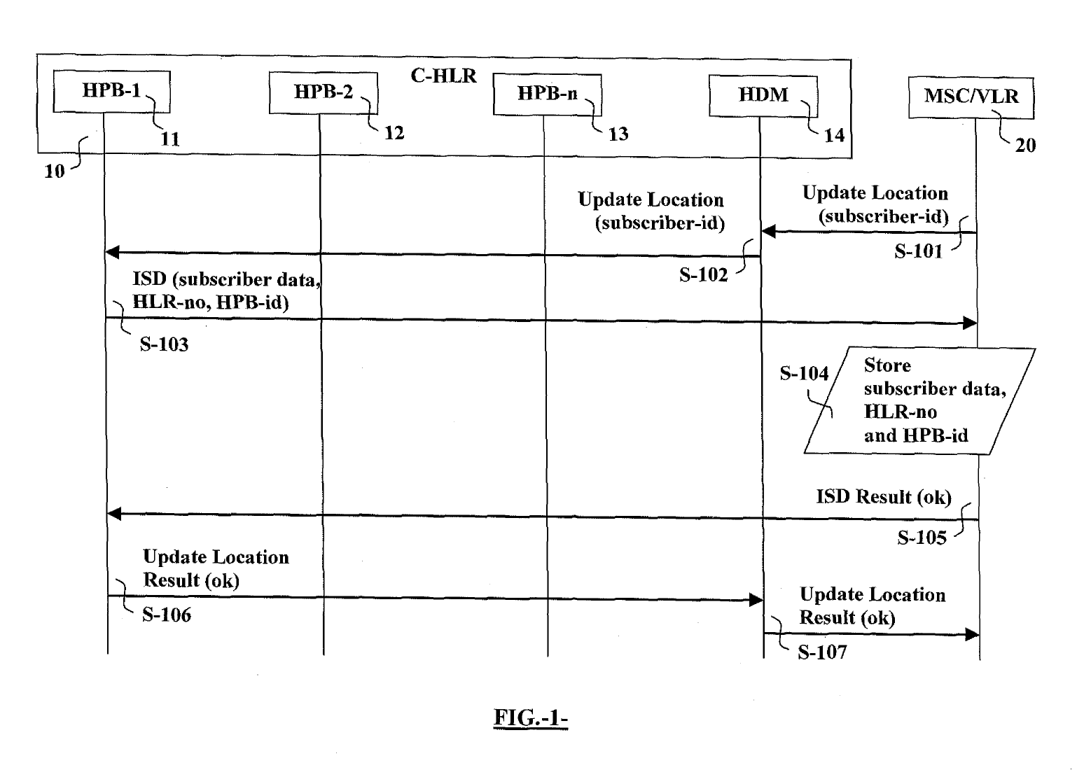

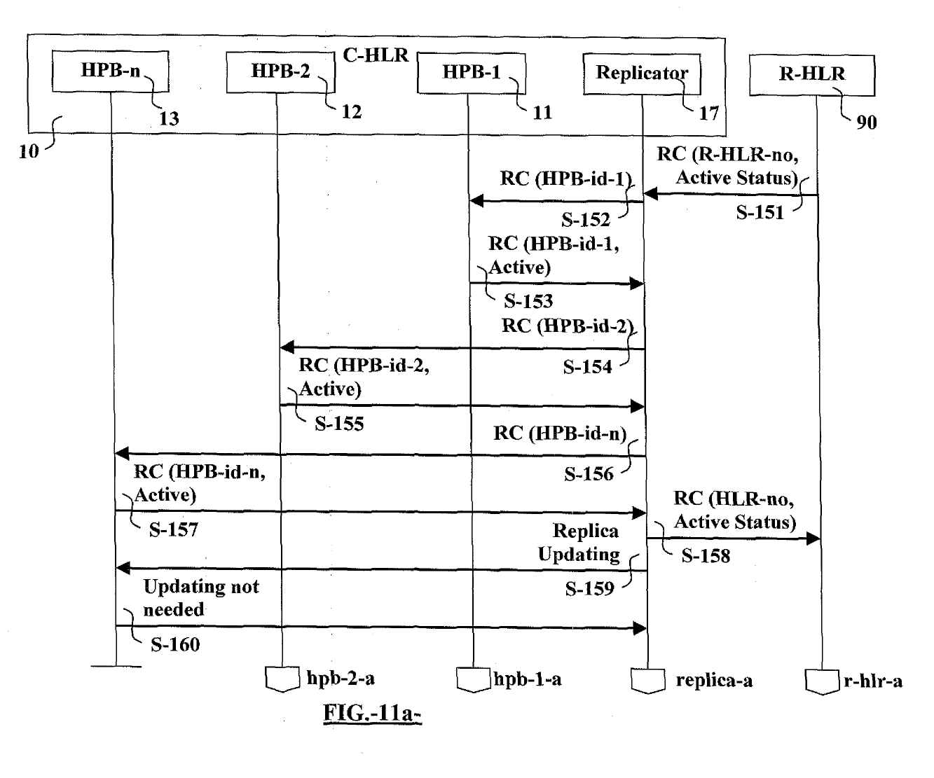

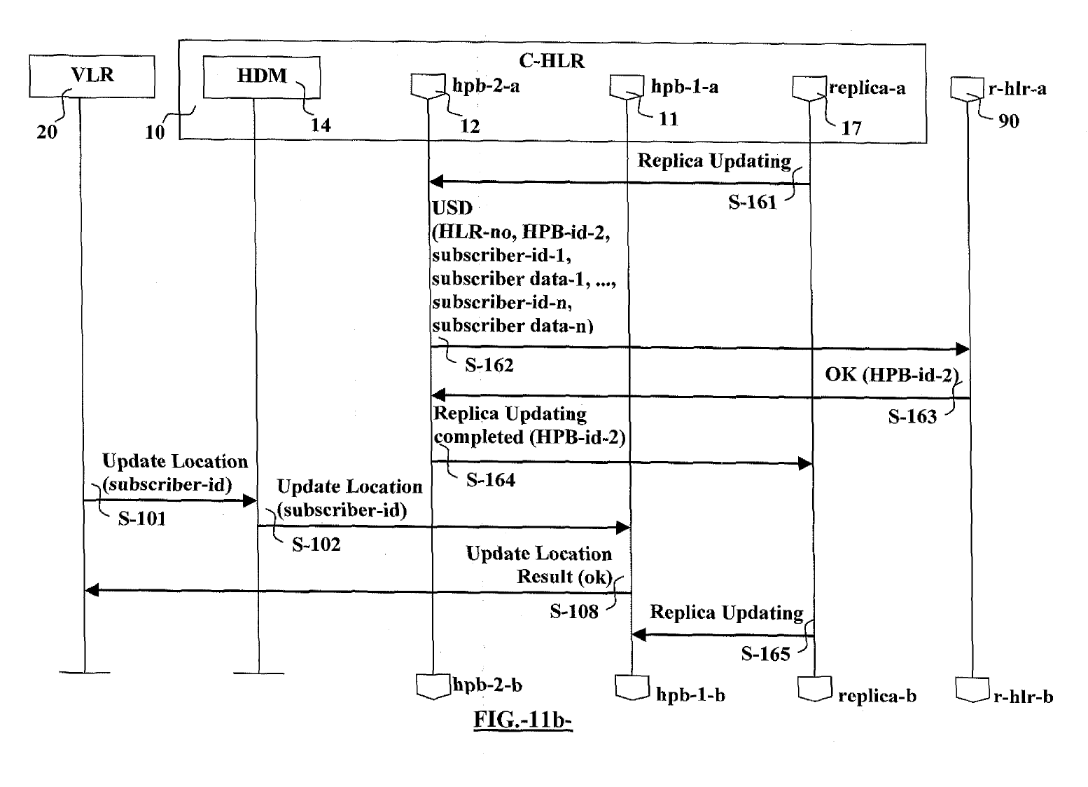

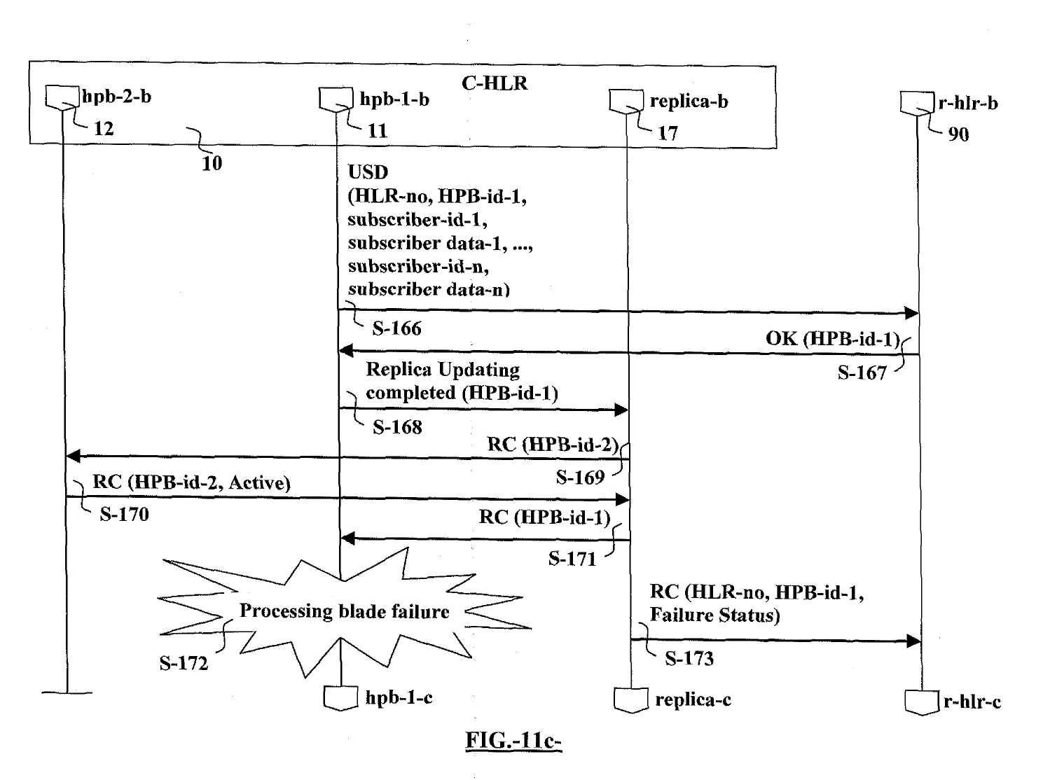

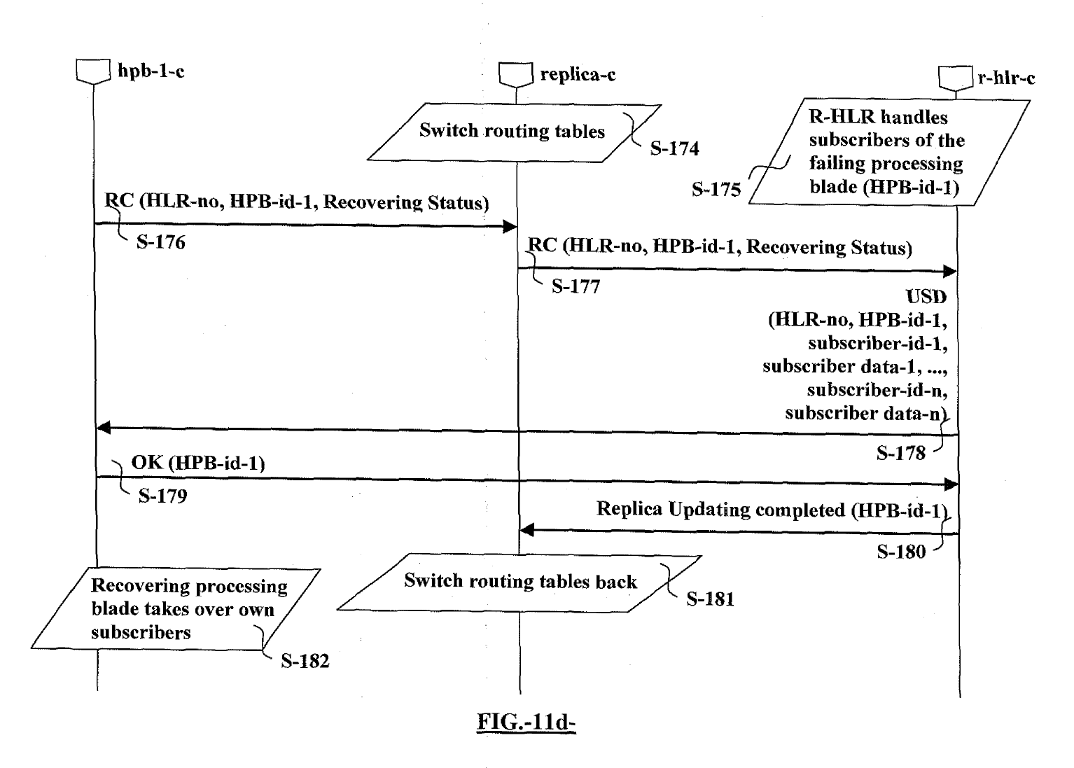

In a second embodiment of the invention partially illustrated in FIG. 1 and more specifically illustrated in FIG. 11b-11c as part of an exemplary redundancy procedure, there is provided a method of updating subscriber data between a clustered subscriber register 10 acting as a HLR, namely a clustered HLR “C-HLR”, and a secondary subscriber register acting as an R-HLR. This method may preferably apply in a scenario as basically illustrated in FIG. 5 wherein a subscriber 1 attaches via a radio interface a 2^{nd} generation mobile network through a base station not shown for the sake of simplicity, reaches a Base Station Centre “BSC” 94 connected with an MSC 92 receiving the subscriber attach, and submitting an update location message towards a VLR 20 in charge of the VLR area where the MSC belongs to. Frequently, the VLR and the MSC are provided as a combination in a unique network node and are commonly referred to as an MSC/VLR.

The method under this second embodiment, as illustrated in FIG. 1 and FIG. 11b, starts with a step S-101 of receiving at the clustered HLR (C-HLR) 10 location data for the subscriber 1 from the VLR (or MSC/VLR as the case might be) 20, which is the serving node currently serving the subscriber in the mobile network.

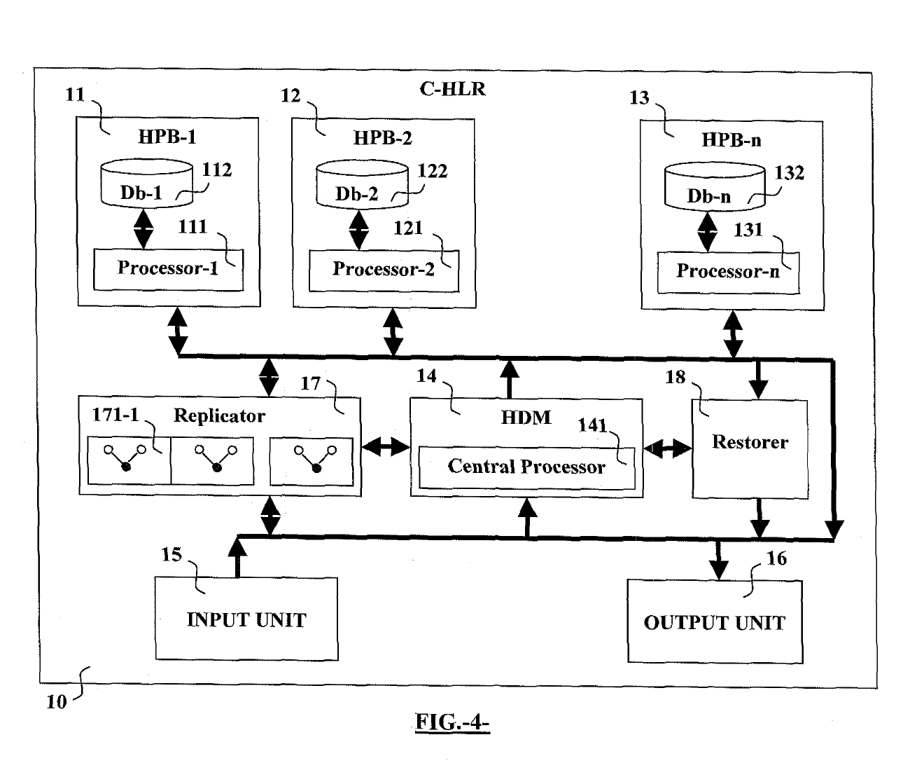

To this end, as illustrated in FIG. 4, the C-HLR 10 includes an input unit 15 arranged for receiving said location data for the subscriber from the VLR 20 in the mobile network. Since this C-HLR comprises a plurality of processing blades 11-13, a particular processing blade 11 must be determined for handling this subscriber. This particular processing blade 11, as each processing blade 11-13, handles a number of subscribers and comprises: a storage 112 arranged for storing subscriber data for the subscriber 1, and a processor 111 arranged for processing a course of actions to be taken for the subscriber depending on subscriber data for said subscriber. To this end, the C-HLR 10 includes a distributor 14, the so-called home distribution module “HDM” in this instant specification, for determining the processing blade 11 currently handling the subscriber. In particular, this distributor may include a central processor 141 for carrying out common routines for all the processing blades as well as for controlling the availability status for each processing blade. Then, the input unit 15 internally passes the location updating message received with location data for the subscriber to the distributor 14, which is the internal entity receiving the location data during this step S-101.

As for the previous embodiment, the sequence of actions illustrated in FIG. 1 and FIG. 11b thus continues with a step S-102 of determining at the distributor 14 of the C-HLR the processing blade 11 for handling the subscriber, and internally passing the location updating message received with location data for the subscriber to said processing blade 11. Then, the processing blade receiving such location updating message, processes and stores the new location, namely an identifier of the VLR 20 currently serving the subscriber and, as illustrated in FIG. 11c, submits in step S-166 towards a secondary subscriber register 90, which in the present embodiment is an R-HLR holding redundant subscriber data for subscribers of the mobile network, a subscriber identity for the subscriber, an identifier of the C-HLR, and an identifier of the processing blade 11 handling the subscriber at the C-HLR.

To this end, as illustrated in FIG. 4, the C-HLR, comprises an output unit 16 arranged for submitting the subscriber identity for the subscriber, the identifier of the C-HLR, and the identifier of the processing blade 11 handling the subscriber towards a secondary subscriber register, in this case the R-HLR 90, in the mobile network.

On the other hand, the secondary subscriber register 90 illustrated in FIG. 10, which in this second embodiment is an R-HLR, comprises an input unit 25 arranged for receiving from the C-HLR 10 the subscriber identity for the subscriber, the identifier of the C-HLR, and the identifier of the processing blade 11 handling the subscriber at the C-HLR; a storage 21 arranged for storing the subscriber data 212 and the subscriber identity 211 for the subscriber, the identifier 213 of C-HLR and the identifier 214 of the processing blade for the subscriber therein; and a processor 24 arranged for processing a course of actions to be taken for the subscriber depending on the received subscriber data.

The method described hereinbefore, as well as the structural elements that form the clustered and the secondary subscriber registers, especially in respect of the above second embodiment, allow recovery procedures such as the so-called redundancy procedure to be carried out for network nodes such as HLR, VLR, HSS, S-CSCF, and R-HLR with higher performance and memory capacity whilst keeping the overall network performance, signalling load and response times up to reasonable levels and measurements.

In the following an exemplary redundancy procedure between a clustered HLR “C-HLR” and a redundant HLR “R-HLR” as illustrated in FIG. 11a to FIG. 11d. The assumption in this exemplary method is that both C-HLR and R-HLR have been configured with the same permanent subscriber data for those so-called primary subscribers in the C-HLR and for those corresponding redundant subscribers in the R-HLR. The non-permanent subscriber data, such as the subscriber location or other service indicators, may be either configured with default values or marked unknown until having adopted a particularly significant value. Once both C-HLR and R-HLR are operating in the mobile network, they both may indicate to each with a certain periodicity whether they are in an active status or not.

The exemplary redundancy procedure illustrated in FIG. 11a starts with a coordination between the C-HLR 10 and the R-HLR 90 of the redundancy procedure for sending subscriber data for those subscribers handled in each processing blade. Such coordination may be initiated by the C-HLR or by the R-HLR. The illustrated exemplary procedure starts when the R-HLR 90 submits during step S-151 a redundancy control “RC” message indicating its own identifier of secondary subscriber register, namely the identifier of the R-HLR, along with an indication of being in an active status, towards the clustered subscriber register, namely the C-HLR 10.

To this end, the input unit 15 in the C-HLR illustrated in FIG. 4 cooperates with a replicator 17 to start an internal redundancy control amongst the different processing blades 11-13 that the C-HLR consists of. For the sake of simplicity, the input unit is not illustrated in the sequence diagram of FIG. 11a to 11b. In an alternative embodiment not illustrated in any drawing, the central processor 141 may include the functions of the replicator 17 so that the latter, as an isolated entity, may be unnecessary.

Again with reference to the method illustrated in FIG. 11a, the replicator 17 receiving the redundancy control “RC” message in step S-151, indicating an active status of the R-HLR 90, sends during steps S-152, S-154, S-156 towards each processing blade 11-13 an internal RC message asking for its individual status. Such query is answered from each processing blade during steps S-153, S-155, S-157 indicating its own identifier of processing blade and its own status, which in this case is an active status from all the processing blades. The replicator 17 in cooperation with the output unit 16, the latter not shown for the sake of simplicity, sends in step S-158 a corresponding redundancy control “RC” message, indicating the own identifier of the C-HLR 10 along with an indication of being in an active status, towards the R-HLR 90. The sending of this redundancy control indicating an active status may be assumed as an implicit trigger for checking the needs for a replica updating, or might start a time gap before triggering such checking.

In principle, a replica updating is needed whenever any non-permanent subscriber data has changed for a subscriber handled in a processing blade. The replica updating is carried out only for changed data in order to keep up-to-date the contents in the R-HLR, just in case the R-HLR has to enter into operation following a certain failure in the C-HLR. As illustrated in FIG. 11a and FIG. 11b, the replicator 17 queries the processing blades 11-13 during steps S-159, S-161, S-165 whether a replica updating is needed or not. In this exemplary method, the processing blade 13 answers in step S-160 that the replica updating is not needed towards the replicator which marks this situation. This particular processing blade 13 is not further shown in the following sequence of actions illustrated in FIG. 11b to FIG. 11d since it does not participate thereof, and in order to facilitate the drawing of further interesting network nodes or actions involving the present nodes.

As receiving the replica updating query during step S-161 in the processing blade 12 illustrated in FIG. 11b, it is found therein that the replica in the R-HLR must be updated for a number of subscriber data. To this end, as illustrated in FIG. 4, the internal processor 121 cooperates with the internal storage 122 in the processing blade 12 to compile a list of subscriber data to be updated in the replica handled in the R-HLR 90.

Regarding the replica updating, and even though changeable non-permanent subscriber data are candidates to be updated, one may assume that permanent subscriber data, which are changeable only by the operator and likely with provisioning or configuration means, may also be included in a replica updating thus making unnecessary the operator intervention in both C-VLR and R-HLR.

Once the processing blade 12 has compiled the list of subscriber data to be updated, it sends in step S-162 such subscriber data along with an identifier of the C-HLR and an identifier of the processing blade 12 towards the R-HLR 90. Such list is used to update the replica in the R-HLR, and an acknowledge message is returned during step S-163 from the R-HLR to the C-HLR including the identifier of the processing blade 12.

To this end, and bearing in mind that the secondary subscriber register, as illustrated in FIG. 10 and claimed by the present invention, is acting as the R-HLR in accordance with this second embodiment, said R-HLR comprises an input unit 25 arranged for receiving from the C-HLR 10 the subscriber identity and the set of subscriber data for each subscriber, the identifier of the C-HLR 10 and the identifier of the processing blade 12 handling the subscribers; and a storage 21 arranged for storing on a subscriber basis the subscriber identity 211 and the set of subscriber data 212 for each subscriber, the identifier 213 of the C-HLR 10 and the identifier 214 of the processing blade 12 handling the subscribers. In addition, the secondary subscriber register acting as R-HLR may also comprise a replicator 27 for coordinating with the C-HLR 10 the redundancy procedure for receiving subscriber data 212 for those subscribers handled in a processing blade 12 identified by a given identifier 214. As previously commented for the structural elements that the C-HLR may comprise, the replicator 27 may be superfluous in the secondary subscriber register acting as R-HLR if the processor 24 is arranged to carry out a corresponding redundancy control and functionality.

Upon receipt in the processing blade 12 in step S-163 of the acknowledge indicating the replica has been updated in the R-HLR 90, the processing blade indicates the completion of such updating in step S-164 to the replicator 17. This indication may be advantageous for operating a state-transition machine 171-1 in the replicator to mark a corresponding status for such processing blade 12. To this end, the C-HLR illustrated in FIG. 4 may also include a state-transition machine 171-1 included in, or in cooperation with, the replicator 17 or the distributor 14 or the central processor 141 included therein.

Back to the sequence of actions illustrate in FIG. 11b and following ones, one may assume that actions modifying the non-permanent subscriber data may occur at any time, even during a redundancy procedure. In order to illustrate such a situation, the sequence of actions in FIG. 11b continues with the reception of a location updating for a subscriber at the C-HLR 10 during a step S-101 from a VLR 20 currently serving the subscriber. As previously discussed above when introducing the method of updating subscriber data between a clustered subscriber register and a secondary subscriber register, both holding subscriber data for subscribers in a mobile network, under this second embodiment, such updating of location data is received in the distributor 14 in cooperation with the input unit 15 of the C-HLR, and internally forwarded towards the processing blade 11 handling the subscriber. The new location data are processed by the local processor 111 and stored in storage 112 in the processing blade 11, and a successful result is returned back to the VLR 20, either directly during step S-108 as illustrated in FIG. 11b, or indirectly through the distributor 14 during steps S-106 and S-107 as shown in FIG. 1. This particular VLR 20 and the distributor 14 are not further shown in the following sequence of actions illustrated in FIG. 11c and FIG. 11d since they do not participate thereof, and in order to facilitate the drawing of further interesting actions involving the present nodes.

At this stage different alternatives may be implemented without substantially departing from the main provisions of the invention. The updating of location data for a subscriber in the C-HLR 10 may trigger a replica updating towards the R-HLR 90 in a first alternative not shown in any drawing, or may be simply be marked as ‘replica pending’ so that a further replica updating query from the replicator 17 may trigger such replica updating for the new location data towards the R-HLR as illustrated in a second alternative shown in FIG. 11b.

In this exemplary method, where the above second alternative is followed, the replicator 17 internally sends during step S-165 the query about needs for replica updating towards the processing blade 11. This processing blade 11, or rather its processor 111, detects that there is a replica updating and compiles a list of subscriber data to be submitted towards the R-HLR 90. This list may include, not only the latest location data updated for one subscriber, but all the subscriber data modified since a last replica updating took place.

Regarding the replica updating, and depending on the total amount of subscriber data to be submitted, the processing blade might need one or more signalling messages such as a so-called Update Subscriber Data “USD”. Where the submission must be segmented into several USDs for submitting all the subscriber data, the identifier of the C-HLR 10 and the identifier of the processing blade 11 is included in each USD along with the subscriber data fitting the signalling message.

As illustrated in FIG. 11c, and once the list of subscriber data to be updated is ready, the processing blade 11 in cooperation with the output unit 16 sends during step S-166 one or more USDs with an amount of subscriber data, the identifier of the C-HLR 10 and the identifier of the processing blade 11 and advantageously with one end-of-transmission indicator to advice there is no further USD to submit. Once the replica has been updated in the R-HLR 90, an acknowledge is returned back to the processing blade 11 during step S-167, and the processing blade receiving such acknowledge sends during step S-168 towards the replicator 17 an indication of having completed the replica updating. As for a previous processing blade, this indication may be advantageous for operating a state-transition machine 171-1 in the replicator 17 to mark a corresponding status for such processing blade 11.

Regarding the coordination of redundancy control and status between C-HLR and R-HLR, they do not necessarily have to be synchronized. Each one may have its own supervision time to indicate to each other its own status.

In this exemplary method, as illustrated in FIG. 11c, the replicator starts a new redundancy control process towards each processing blade 11-13. To this end, an internal RC message asking for its individual status is submitted towards the processing blade 12 in step S-169 and answered during step S-170 from the processing blade 12 indicating its own identifier of processing blade and its own status, which in this case is active. This particular processing blade 12 is not further shown in the following sequence of actions illustrated in FIG. 11d since it does not participate thereof, and in order to facilitate the drawing of further interesting actions involving the present nodes.

The process new redundancy control process continues as illustrated in FIG. 11c by sending from the replicator 17 during step S-171 an internal RC message asking for its individual towards the processing blade 11. At this stage, this processing blade 11 may have suffered a failure so that it is not able to answer such message. After a reasonable time gap, likely configurable at the replicator 17, or at the central processor 141, the replicator 17 may assume the failure, and may inform about it during step S-173 towards the R-HLR 90, indicating the identifier of the C-HLR and the identifier of the failing processing blade 11.

This information about the failing processing blade 11 at the C-HLR 10 is understood by the R-HLR as an implicit indication to be ready to accept signalling traffic for subscribers marked with such identifier of processing blade in its local storage 214.

The exemplary method continues as illustrated in FIG. 11d with the replicator 17 triggering the switching of routing tables during step S-174 so that signalling messages addressing the failing processing blade in the C-HLR are forwarded towards the R-HLR. In a preferred alternative solution for this embodiment, the routing tables are included in the distributor 14, so that the distributor may identify the processing blade in charge of a given subscriber and, as detecting such subscriber is handled in a failing processing blade, may forward such signalling message towards the R-HLR. In another alternative solution, the routing tables remain in lower protocol layers and are configured on a processing blade basis, so that upon failure in a processing blade basis, said lower protocol layers are informed and may switch the tables and inspect signalling messages for determining whether a forwarding towards the R-HLR should take place or not. This second alternative seems to be less efficient than the previous one though may be more backwards compatible than the first one.

One the routing tables have been switched, the R-HLR 90 is ready in step S-175 for handling subscribers previously in charge of the failing processing blade, and thus continues until the failing processing blade recovers and is operative again.

As illustrated in FIG. 11d, once the previously failing processing blade 11 is active again, it sends towards the replicator 17 during step S-176 an RC message indicating its identifier of processing blade as well as its recovering status. The replicator 17 forwards the RC message indicating the recovering status along with the identifier of the C-HLR and the identifier of the recovering processing blade 11 during step S-177 towards the R-HLR 90.

Depending on how long the failure lasted, a number of subscriber data might have changed whilst the corresponding subscribers were handled by the R-HLR. Upon recovery of the processing blade 11 in the C-HLR, the R-HLR may need to update the former with the replica contents in its current values. To this end, the R-HLR 90 prepares a list with the changed subscriber data, mainly non-permanent subscriber data but also permanent subscriber data changed by the operator if the failure lasted quite a long time. Then, the R-HLR submits during step S-178 those subscriber data that need to be updated in the recovering processing blade 11 of the C-HLR, along with an identifier of the C-HLR and an identifier of the recovering processing blade 11. As before, one or more signalling USD messages may be required to this end, each USD including the identifier of the C-HLR and the identifier of the recovering processing blade 11.

Once the changed subscriber data have been updated in the recovering processing blade, a successful acknowledge is returned during step S-179 from the recovering processing blade 11 to the R-HLR 90. Eventually, the R-HLR may send during step S-180 towards the replicator 17 an indication of having completed the replica updating. As for a previous processing blade, this indication may be advantageously used for operating again the state-transition machine 171-1 in the replicator 17 to mark a corresponding active status for such processing blade 11. This indication may be understood at the replicator 17 as an implicit indication that the recovering processing blade 11 has recovered and is now in an active status again. Then, the replicator 17 switches back the routing tables during step S-181 so that signalling messages currently addressing the R-HLR are internally forwarded to the recovered processing blade 11 in the C-HLR. As commented before, in the preferred alternative solution for this embodiment, the routing tables are included in the distributor 14, whereas in another alternative solution, the routing tables remain in lower protocol layers. After having switched back the routing tables, the recovered processing blade 11, now in active status takes over in step S-182 its own subscribers again.

At this stage, the interesting part of a redundancy procedure for the purpose of the present invention does not require further explanation, but stating that the redundancy control to mutually check the active status between both C-HLR and R-HLR continues as previously explained, as well as the internal redundancy control to check the active status of the processing blades 11-13 in the C-HLR.

Nevertheless, after having concluded a recovery of a processing blade within the above redundancy procedure, and depending on different implementation alternatives, there may be a need for a so-called restoration procedure. As exemplary commented above, whilst some subscribers were temporarily served by the R-HLR due to a failure in the processing blade primary intended for handling said subscribers, there might have been a number of location updating from different VLRs for a number of subscribers. In this situation, the said VLRs might have got the identifier of the R-HLR presently handling such subscribers. After the recovery and switching back of routing tables, the identifier of the HLR handling the subscriber stored in each VLR might be the identifier of the R-HLR instead of being the identifier of the C-HLR. The restoration procedure is an advantageous procedure to ensure this situation is properly solved and will be further explained in detail after having discussed a third embodiment of the invention following this.

In a third embodiment of the invention illustrated in FIG. 1 and partially anticipated when discussing the second embodiment illustrated in FIG. 11b-11c, there is provided a method of updating subscriber data between a clustered subscriber register 10 acting as a HLR, namely a clustered HLR “C-HLR”, and a secondary subscriber register acting as a VLR. This method, as for the second embodiment, may preferably apply in the scenario basically illustrated in FIG. 5 wherein a subscriber 1 attaches via a radio interface a 2^{nd} generation mobile network trough a base station not shown for the sake of simplicity, the subscriber reaches a BSC 94 connected with an MSC 92 receiving the subscriber attach, and submitting an update location message towards a VLR 20 in charge of the VLR area where the MSC belongs to. Frequently, the VLR and the MSC are provided as a combination in a unique network node and are commonly referred to as an MSC/VLR.

The method in this third embodiment, as illustrated in FIG. 1 and partially in FIG. 11b, starts with a step S-101 of receiving at the C-HLR 10 location data for the subscriber 1 from the VLR (or MSC/VLR as the case might be) 20, which is the serving node currently serving the subscriber in the mobile network.

To this end, as already commented for the second embodiment and as illustrated in FIG. 4, the C-HLR 10 includes an input unit 15 arranged for receiving said location data for the subscriber from the VLR 20 in the mobile network. Since this C-HLR comprises a plurality of processing blades 11-13, a particular processing blade 11 must be determined for handling this subscriber. This particular processing blade 11, as each processing blade 11-13, handles a number of subscribers and comprises: storage 112 arranged for storing subscriber data for the subscriber 1, and a processor 111 arranged for processing a course of actions to be taken for the subscriber depending on subscriber data for said subscriber. To this end, the C-HLR 10 includes a distributor 14, the so-called HDM in this instant specification, for determining the processing blade 11 currently handling the subscriber. In particular, this distributor may include a central processor 141 for carrying out common routines for all the processing blades as well as for controlling the availability status for each processing blade. Then, the input unit 15 internally passes the location updating message received with location data for the subscriber to the distributor 14, which is the internal entity receiving the location data during this step S-101.

On the other hand, as illustrated in FIG. 10, the secondary subscriber register acting as a VLR comprises an output unit 26 arranged for submitting location data for the subscriber towards the C-HLR 10, this location data including an identifier of the subscriber 1 and an identifier of the VLR 20. For the purpose of the present invention a subscriber identity and an identifier of a subscriber may be interpreted as equivalent terms, even if not having always the same value, or if replaced at a clustered or secondary register by another subscriber identity or identifier.

As for the second embodiment, the sequence of actions illustrated in FIG. 1 and FIG. 11b thus continues for this third embodiment with a step S-102 of determining at the distributor 14 of the C-HLR the processing blade 11 for handling the subscriber, and internally passing the location updating message received with location data for the subscriber to said processing blade 11.

Then, as shown in FIG. 1, the processing blade 11 receiving such location updating message at the C-HLR, processes and stores the new location, namely the identifier of the VLR 20 currently serving the subscriber, and submits in step S-103 towards the secondary subscriber register 20, which in this third embodiment is said VLR 20, a subscriber identity for the subscriber, an identifier of the C-HLR, and an identifier of the processing blade 11 handling the subscriber at the C-HLR. The submission in the above step S-103 of this method also includes, for this third embodiment, a set of subscriber data along with the subscriber identity for the subscriber, the identifier of the C-HLR, and the identifier of the processing blade 11, and a so-called Insert Subscriber Data “ISD” message may be used for this purpose.

To this end, as illustrated in FIG. 4, the C-HLR comprises an output unit 16 arranged for submitting the subscriber identity and the set of subscriber data for the subscriber 1, the identifier of the C-HLR, and the identifier of the processing blade 11 handling the subscriber towards a secondary subscriber register, which in this case is the VLR 20, in the mobile network. On the other hand, the secondary subscriber register 20 illustrated in FIG. 10, which in this third embodiment is the VLR 20, comprises an input unit 25 arranged for receiving from the C-HLR 10 the subscriber identity and subscriber data for the subscriber, the identifier of the C-HLR, and the identifier of the processing blade 11 handling the subscriber at the C-HLR.

The VLR 20 receiving the set of subscriber data and the subscriber identity for the subscriber, the identifier of the C-HLR, and the identifier of the processing blade 11, stores them during step S-104 and returns a successful result during step S-105 towards the processing blade 11 handling the corresponding subscriber at the C-HLR 10.

To this end, the secondary subscriber register 20 illustrated in FIG. 10, which in this third embodiment is the VLR 20, comprises a storage 21 arranged for storing the subscriber identity 211 and the subscriber data 212 for the subscriber, the identifier 213 of C-HLR and the identifier 214 of the processing blade 11 for the subscriber at the C-HLR; and a processor 24 arranged for processing a course of actions to be taken for the subscriber depending on the received subscriber data.

The processing blade 11 handling this subscriber may now return a successful result for the location updating procedure towards the VLR 20 currently serving the subscriber 1, either directly during a step S-108 as illustrated in FIG. 11b, or indirectly through the distributor 14 during steps S-106 and S-107 as shown in FIG. 1.

At this stage, once the method for location updating between a C-HLR and a VLR has been discussed in accordance with this third embodiment, the restoration procedure anticipated above can be further discussed in detail.

In principle, the so-called restoration procedure is one amongst the recovery procedures that may be applied after having recovered from a failure situation. This might be the case where a subscriber register has suffered a sort of restart and a data dumping has taken place, likely from a reload tape or disk. This might be also the case where an R-HLR has been handling the subscribers of a primary HLR during the failure, and subscriber data have been changing therein before recovering and reloading the primary HLR. In this context, the primary HLR is understood as the HLR primary intended to hold subscriber data for a number of such subscribers. Generally speaking, the restoration procedure may take place where subscriber data stored for subscribers of a primary HLR in one or more VLRs might have erroneous data, or data not supposed to be up-to-data.

In particular and for the purpose of the present invention, the restoration procedure may take place where subscriber data stored in one or more VLRs for subscribers of a processing blade 11 of a C-HLR might have erroneous data, or data not supposed to be up-to-data, such as the case might be where the exemplary redundancy procedure explained above in relation with the second embodiment has taken place, or where a data reload has taken place after having suffered a sort of restart at a processing blade 11 of a C-HLR.

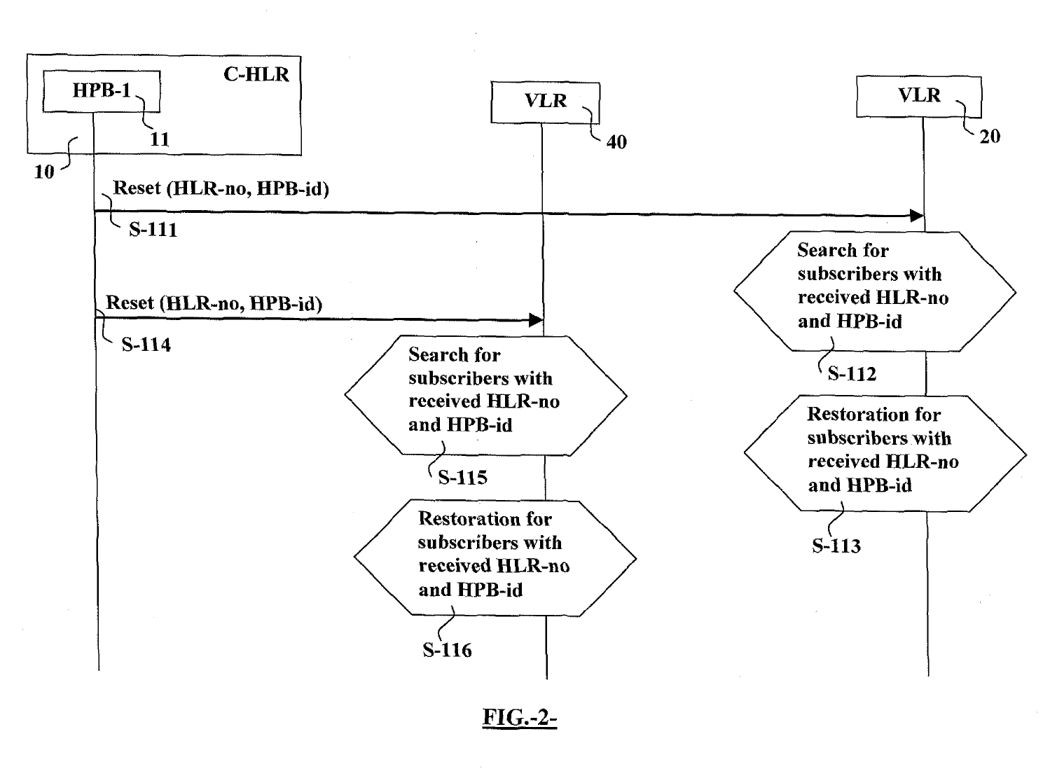

Therefore, an exemplary restoration procedure may take place upon detection of one of the above conditions for a processing blade 11 at the C-HLR 10. Following the second or third embodiments discussed above and as illustrated in FIG. 2, the processing blade 11 determines those VLRs 20, 40 which identifier is stored as location data for these subscribers handled in said processing blade, and sends a reset message including the identifier of the C-HLR 10 and the identifier of the processing blade 11 in respective steps S-111 and S-114 towards said VLRs 20, 40. In particular, amongst said VLRs there may be a clustered subscriber register 40 acting as a clustered VLR “C-VLR” 40, or a secondary subscriber register 20 acting as a non-clustered VLR.

To this end, as FIG. 4 illustrates, the C-HLR may comprise a restorer 18, which in cooperation with the processor 111 of the processing blade 11 obtains from storage 112 those VLRs 20, 40 which identifier is stored as location data for the subscribers handled in said processing blade, the restorer 18 cooperating with the output unit 16 for submitting the reset message with the identifier of the C-HLR 10 and the identifier of the processing blade 11 towards said VLRs 20, 40. Alternatively, the restorer 18 might be unnecessary if the central processor 141 is arranged for carrying out the required steps and functionality of this restoration procedure.

The VLRs 20, 40 receiving such reset message in steps S-111 and S-114 respectively, initiate its local restoration by firstly searching in respective steps S-112 and S-115 for subscribers with the received identifier of the C-HLR 10 and the identifier of the processing blade 11, and by secondly triggering in respective steps S-113 and S-116 a restoration for such subscribers, which basically may imply the withdrawal of such subscribers to force a new location updating for them so that current up-to-data subscriber data may be further received from the C-HLR 10.

As already commented, these VLRs may be implemented with a clustered subscriber register acting as a clustered VLR “C-VLR” 40, or with a secondary subscriber register acting as a non-clustered VLR 20.

Therefore, as illustrated in FIG. 7, a C-VLR 40 may comprise an input unit 45 cooperating with a restorer 48 for receiving the reset message and a number of processing blades 41-43, each processing blade 42 having storage 422 for storing subscriber data for a number of subscribers and a processor 421 arranged for processing the course of actions to be taken for the subscribers depending on subscriber data for each subscriber, in this case, for triggering the withdrawal of subscribers found with the identifier of the C-HLR 10 and with the identifier of the processing blade 11 in the storage 422. Alternatively, the restorer 48 might be unnecessary if the central processor 441 carries out corresponding restoration functions in lieu of the restorer.

On the other hand, a secondary subscriber register 20 acting as a non-clustered VLR 20 may comprise, as illustrated in FIG. 10, an input unit 25 cooperating with a restorer 28 for receiving the reset message and a with a processor 24 arranged for processing the course of actions to be taken for the subscribers depending on subscriber data for each subscriber in storage 21. In this case, for triggering the withdrawal of subscribers in storage 211 found with the identifier of the C-HLR 10 in storage 213 and with the identifier of the processing blade 11 in storage 214. Alternatively as for other embodiments, the restorer 28 might be unnecessary if the central processor 24 carries out corresponding restoration functions in lieu of the restorer.

As for previous embodiments, the method described hereinbefore for this third embodiment, as well as the structural elements that form the clustered and the secondary subscriber registers, especially in respect of the above third embodiment, allow recovery procedures such as the so-called restoration procedure to be carried out for network nodes such as HLR, VLR, HSS, S-CSCF, and R-HLR with higher performance and memory capacity whilst keeping the overall network performance, signalling load and response times up to reasonable levels and measurements.

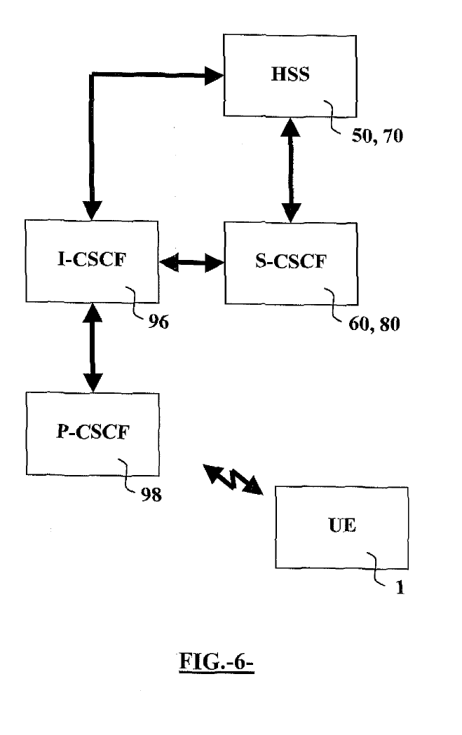

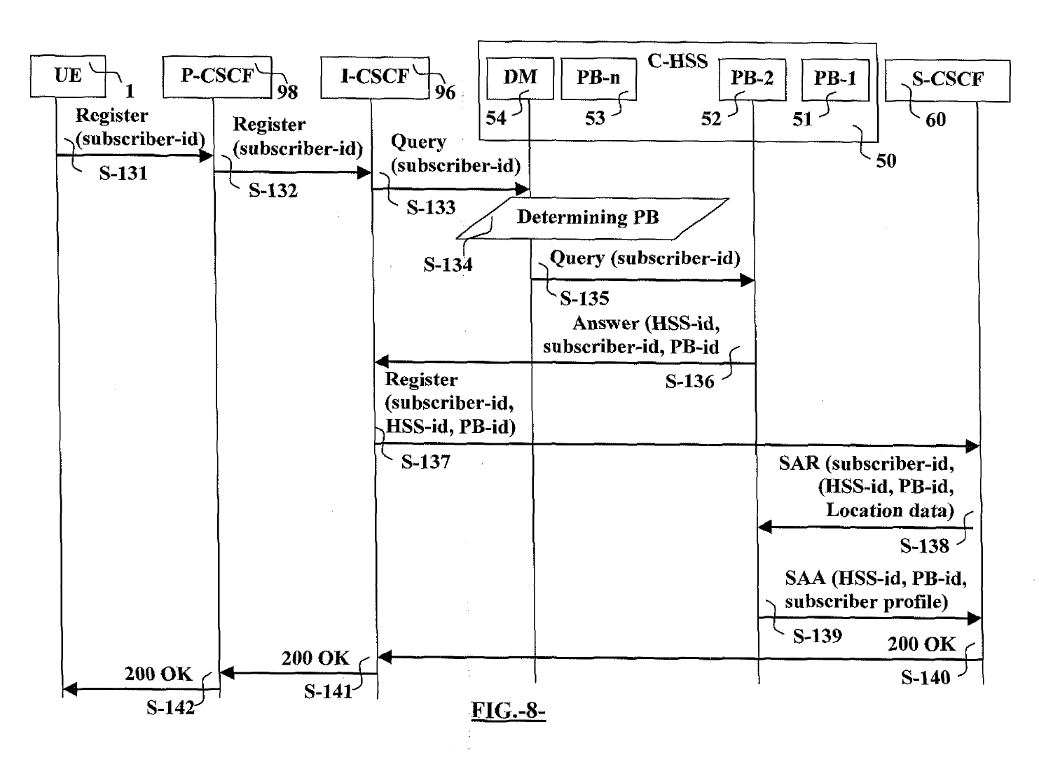

In a fourth embodiment of the invention illustrated in FIG. 8 there is provided a method of updating subscriber data between a clustered subscriber register 50 acting as a HSS, namely a clustered HSS “C-HSS”, and a secondary subscriber register acting as an S-CSCF. This method may preferably apply in the scenario basically illustrated in FIG. 6 wherein a subscriber 1 attaches via a radio interface an IP Multimedia Subsystem “IMS” of a 3^{rd} generation mobile network through radio premises not shown for the sake of simplicity. The subscriber registers in a P-CSCF 98, from where a corresponding registration message is submitted towards an I-CSCF 96. The I-CSCF 96 queries the HSS 50, 70 in order to obtain capabilities required for assigning a serving node for serving the subscriber. Once such capabilities are received from the HSS, the I-CSCF selects and assigns an S-CSCF 60, 80 suitable for serving the subscriber, and submits the registration message towards said S-CSCF. The S-CSCF then submits a message towards the HSS indicating to be assigned for serving the user, the indication including an identifier of said S-CSCF, an obtains from the HSS a user profile, including the subscriber data for the subscriber, along with an identifier of the HSS.

The method in this third embodiment, as illustrated in FIG. 8, starts with a step S-131 of registering a subscriber 1 into a P-CSCF 98 of the IMS. The P-CSCF 98 submits the registration message towards the I-CSCF 96 in a step S-132. The I-CSCF 96 queries a C-HSS 50 during step S-133 to obtain capabilities required for assigning an S-CSCF.

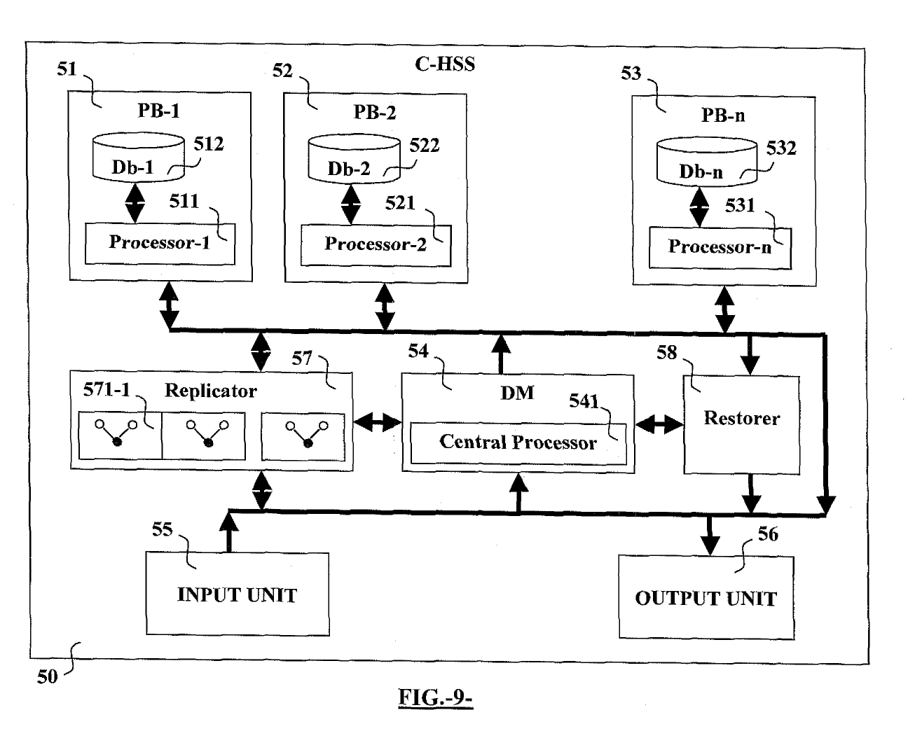

To this end, as illustrated in FIG. 9, the C-HSS 50 includes an input unit 55 arranged for receiving said query about required capabilities for the subscriber from the I-CSCF 96. Since this C-HSS comprises a plurality of processing blades 51-53, a particular processing blade 52 must be determined for handling this subscriber. This particular processing blade 52, as each processing blade 51-53, handles a number of subscribers and comprises: storage 522 arranged for storing subscriber data for the subscriber 1, and a processor 521 arranged for processing a course of actions to be taken for the subscriber depending on subscriber data for said subscriber. To this end, the C-HSS 50 includes a distributor 54, the so-called DM in this instant specification, for determining the processing blade 52 currently handling the subscriber. In particular, this distributor may include a central processor 541 for carrying out common routines for all the processing blades as well as for controlling the availability status for each processing blade. Then, the input unit 55 internally passes the query to the distributor 54, which is the internal entity receiving the query during this step S-133.

The sequence of actions illustrated in FIG. 8 thus continues with a step S-134 of determining at the distributor 54 of the C-HSS 50 the processing blade 12 handling the subscriber, and internally passing the query received for the subscriber to said processing blade 12 during step S-135. Then, the processing blade receiving such query, or rather its local processor 521, returns during step S-136 an identifier of the C-HSS 50 and an identifier of the processing blade 12 along with the requested capabilities.

To this end, the local processor 521 cooperates with an output unit 56 for returning these data during the step S-136. Alternatively and depending on different implementations, the central processor 541 might also participate in this step of returning the identifier of the C-HSS 50 and the identifier of the processing blade 12 along with the requested capabilities.

In view of the received capabilities, the I-CSCF 96 selects an S-CSCF 60 fitting such capabilities and assigns it to the subscriber by forwarding to said S-CSCF 60 during step S-137 the registration message, after having included therein the received identifier of the C-HSS 50 and the received identifier of the processing blade 12. Upon receipt of such registration message, the S-CSCF 60 informs the C-HSS of being assigned for serving the subscriber and updates the subscriber location data therein, namely an identifier of the S-CSCF currently serving the subscriber, by submitting during step S-138 this location data along with the identifier of the C-HSS 50 and the identifier of the processing blade 12.

To this end, the secondary subscriber register 60 acting as the S-CSCF 60 in this fourth embodiment, as illustrated in FIG. 10, comprises an output unit 26 cooperating with a processor 24 for this submission.

The C-HSS 50 receiving such location updating message, downloads towards the S-CSCF a subscriber profile for the subscriber along with the identifier of the C-HSS 50 and the identifier of the processing blade 12, the subscriber profile including the subscriber data for the subscriber. The S-CSCF 60 receiving the subscriber profile and a subscriber identity for the subscriber, the identifier of the C-HSS, and the identifier of the processing blade 12, stores them during a step not shown in any drawing, and returns a successful registration result during step S-140 towards the I-CSCF 96, the I-CSCF forwarding this result during step S-141 towards the P-CSCF, and the latter forwarding it towards the subscriber 1 during step S-142.

To this end, as illustrated in FIG. 9, the C-HSS 50 comprises an input unit 55 arranged for receiving said location data for the subscriber from the S-CSCF 60 and an output unit 56 arranged for submitting the subscriber identity and subscriber profile for the subscriber, the identifier of the C-HSS 50, and the identifier of the processing blade 12 handling the subscriber towards a secondary subscriber register 60, which in this case is the S-CSCF 60 in the IMS network.

On the other hand, the secondary subscriber register 60 illustrated in FIG. 10, which in this fourth embodiment is the S-CS CF 60, comprises an input unit 25 arranged for receiving from the C-HSS 50 the subscriber identity and subscriber profile for the subscriber, the identifier of the C-HSS 50, and the identifier of the processing blade 12 handling the subscriber at the C-HSS; a storage 21 arranged for storing the subscriber identity 211 and the subscriber data 212 in the subscriber profile for the subscriber, the identifier 213 of C-HSS and the identifier 214 of the processing blade 12 for the subscriber at the C-HSS; and a processor 24 arranged for processing a course of actions to be taken for the subscriber depending on the received subscriber data.

This method described for this fourth embodiment, as well as the structural elements that form the clustered and the secondary subscriber registers, allow recovery procedures such as the so-called restoration procedure to be carried out for the HSS and the S-CSCF, with higher performance and memory capacity whilst keeping the overall network performance, signalling load and response times up to reasonable levels and measurements. In this respect, the method in this fourth embodiment may include a step of submitting, after having recovered from a failure affecting a processing blade, a reset indication from the C-HSS 50 towards those S-CSCF 60, 80 holding subscriber data for those subscribers handled by the recovered blade, the reset indication including the identifier of the C-HSS 50 and the identifier of the recovered processing blade. Even though this procedure is not illustrated in any drawing where applying between a C-HSS and a S-CSCF, those skilled in the art would appreciate that the teaching in the above third embodiment may also be applied between the C-HSS and the S-CSCF.

Moreover, the clustered subscriber register acting as a C-HSS may have a redundant HSS for holding redundant subscriber data for subscribers hold by the C-HSS. The method in this fourth embodiment may thus include a step of coordinating between the C-HSS 50 and the redundant HSS a redundancy procedure for sending subscriber data for those subscribers handled in a processing blade 51-53 identified by a given identifier. Even though this procedure applying between a C-HSS and a redundant HSS is not illustrated in any drawing, those skilled in the art would appreciate that the teaching in the above second embodiment may also be applied between the C-HSS and the redundant HSS.

Furthermore, the clustered subscriber register may also act as a S-CSCF wherein a similar architecture as the ones illustrated in FIGS. 4, 7 and 9 may be applicable to this end.

Therefore, the method described hereinbefore for the four embodiments, as well as the structural elements that build up the clustered and the secondary subscriber registers, allow recovery procedures such as the so-called redundancy procedure and the so-called restoration procedure to be carried out for network nodes such as HLR, VLR, HSS, S-CSCF, and R-HLR with higher performance and memory capacity whilst keeping the overall network performance, signalling load and response times up to reasonable levels and measurements.

The invention is described above in respect of several embodiments in an illustrative and non-restrictive manner. Obviously, variations, and combinations of these embodiments are possible in light of the above teachings, and any modification of the embodiments that fall within the scope of the claims is intended to be included therein.

1. A clustered subscriber register holding subscriber data for subscribers in a mobile network, the subscriber data comprising subscription data and location data for each subscriber, the clustered subscriber register:
an input unit arranged for receiving location data for a subscriber from a serving node in the mobile network; and
an output unit arranged for submitting a subscriber identity for the subscriber and an identifier of the clustered subscriber register towards a secondary subscriber register in the mobile network;
a plurality of processing blades, each processing blade handling a number of subscribers and comprising:
a storage arranged for storing subscriber data for the subscriber, and a processor arranged for processing a course of actions to be taken for the subscriber depending on subscriber data for the subscriber;
a distributor for determining the processing blade currently handling the subscriber; and
the output unit being arranged for submitting, along with subscriber identity and the identifier of the clustered subscriber register, an identifier of the processing blade handling the subscriber.

2. The clustered subscriber register of claim 1, wherein the input unit is arranged for receiving an upgraded operation to process a course of actions for the subscriber, the upgraded operation including the subscriber identity for the subscriber and the identifier of the processing blade handling the subscriber.

3. The clustered subscriber register of claim 1, wherein the output unit is arranged for submitting, along with the subscriber identity for the subscriber, the identifier of the clustered subscriber register and the identifier of the processing blade, a set of subscriber data for the subscriber towards the secondary subscriber register in the mobile network.

4. The clustered subscriber register of claim 1, where acting as a Visitor Location Register “VLR” holding subscriber data for subscribers roaming in a VLR area of the mobile network, the input unit being arranged for receiving location data for the subscriber from a Mobile Switching Centre “MSC” currently serving the subscriber, the output unit being arranged for submitting to a Home Location Register “HLR”, which holds subscriber data for subscribers of the mobile network, the subscriber identity for the subscriber, the identifier of the Visitor Location Register and the identifier of the processing blade handling the subscriber therein.

5. The clustered subscriber register of claim 3, acting as a Home Location Register “HLR” holding subscriber data for subscribers of the mobile network, the input unit being arranged for receiving location data for the subscriber from a Visitor Location Register “VLR”, which is serving the subscriber and holds subscriber data for subscribers roaming in a VLR area of the mobile network, the output unit being arranged for submitting to a redundant Home Location Register “R-HLR”, which holds redundant subscriber data for subscribers of the mobile network, the subscriber identity and the set of subscriber data for the subscriber, the identifier of the Home Location Register and the identifier of the processing blade handling the subscriber therein.

6. The clustered subscriber register of claim 5, further comprising a replicator for coordinating with the redundant Home Location Register “R-HLR” a redundancy procedure for sending subscriber data for subscribers handled in a processing blade identified by a given identifier.

7. The clustered subscriber register of claim 6, wherein the replicator further comprises a state-transition machine operating on a processing blade basis to determine the status of the redundancy procedure on course for each processing blade.

8. The clustered subscriber register of claim 3, acting as a Home Location Register “HLR” holding subscriber data for subscribers of the mobile network, the input unit being arranged for receiving location data for the subscriber from a Visitor Location Register “VLR”, which is serving the subscriber and holds subscriber data for subscribers roaming in a VLR area of the mobile network, the output unit being arranged for submitting to the Visitor Location Register the subscriber identity and the set of subscriber data for the subscriber, the identifier of the Home Location Register and the identifier of the processing blade handling the subscriber therein.

9. The clustered subscriber register of claim 3, acting as a Home Subscriber Server “HSS” holding subscriber data for subscribers of an IP Multimedia Subsystem “IMS” in the mobile network, the input unit being arranged for receiving location data for the subscriber from a Serving Call Session Control Function server “S-CSCF”, which is assigned for serving the subscriber in the IMS, and the output unit being arranged for submitting to said Serving Call Session Control Function server “S-CSCF” the subscriber identity and the set of subscriber data for the subscriber, the identifier of the Home Subscriber Server and the identifier of the processing blade handling the subscriber.

10. The clustered subscriber register of claims 8, further comprising a restorer arranged for submitting, after having recovered from a failure affecting a processing blade, a reset indication to secondary subscriber registers holding subscriber data for those subscribers handled by the recovered blade, the reset indication including the identifier of the clustered subscriber register and the identifier of the recovered processing blade.

11. A secondary subscriber register arranged for holding subscriber data for subscribers in a mobile network, the subscriber data comprising subscription data and location data for each subscriber, the secondary subscriber register:
an input unit arranged for receiving from a clustered subscriber register, which holds subscriber data for a subscriber in the mobile network, a subscriber identity for the subscriber along with an identifier of the clustered subscriber register;
a storage arranged for storing subscriber data, the subscriber identity, and the identifier of the clustered subscriber register for the subscriber;
a processor arranged for processing a course of actions to be taken for the subscriber depending on the received subscriber data;
the input unit being arranged for receiving from the clustered subscriber register, along with the subscriber identity and the identifier of the clustered subscriber register, an identifier of a processing blade handling the subscriber at the clustered subscriber register; and
the storage being arranged for also storing the identifier of the processing blade for the subscriber.

12. The secondary subscriber register of claim 11, further comprising an output unit arranged for submitting towards the clustered subscriber register an upgraded operation to process a course of actions for the subscriber, the upgraded operation including the subscriber identity for the subscriber and the identifier of the processing blade handling the subscriber.

13. The secondary subscriber register of claim 11, wherein the input unit is arranged for receiving a set of subscriber data for the subscriber, along with the subscriber identity for the subscriber, the identifier of the clustered subscriber register and the identifier of the processing blade, from the clustered subscriber register in the mobile network.

14. The secondary subscriber register of claim 11, acting as a Home Location Register “HLR” holding subscriber data for subscribers of the mobile network, the input unit being arranged for receiving from a Visitor Location Register “VLR”, which is currently serving the subscriber and holds subscriber data for subscribers roaming in a VLR area of the mobile network, the subscriber identity for the subscriber, the identifier of the Visitor Location Register and the identifier of the processing blade handling the subscriber.

15. The secondary subscriber register of claim 13, acting as a redundant Home Location Register “R-HLR” holding redundant subscriber data for subscribers of the mobile network, the input unit being arranged for receiving from a clustered Home Location Register, which holds subscriber data for subscribers of the mobile network, the subscriber identity and the set of subscriber data for the subscriber, the identifier of the Home Location Register and the identifier of the processing blade handling the subscriber.

16. The secondary subscriber register of claim 15, further comprising a replicator for coordinating with the clustered Home Location Register “HLR” a redundancy procedure for receiving subscriber data for those subscribers handled in a processing blade identified by a given identifier.

17. The secondary subscriber register of claim 16, wherein the replicator further comprises a state-transition machine operating on a processing blade basis to determine the status of the redundancy procedure on course for each processing blade.

18. The secondary subscriber register of claim 13, acting as a Visitor Location Register “VLR” currently serving the subscriber and holding subscriber data for subscribers roaming in a VLR area of the mobile network, further comprising an output unit arranged for submitting location data for the subscriber towards a Home Location Register “HLR”, which holds subscriber data for subscribers of the mobile network, and wherein the input unit is arranged for receiving from the Home Location Register “HLR” the subscriber identity and the set of subscriber data for the subscriber, the identifier of the Home Location Register and the identifier of the processing blade handling the subscriber.

19. The secondary subscriber register of claim 13, acting as a Serving Call Session Control Function server “S-CSCF” serving the subscriber in an IP Multimedia Subsystem “IMS” of the mobile network, further comprising an output unit arranged for submitting location data for the subscriber towards a Home Subscriber Server “HSS”, which holds subscriber data for subscribers of the IP Multimedia Subsystem “IMS” in the mobile network, and the input unit being arranged for receiving from the Home Subscriber Server “HSS” the subscriber identity and the set of subscriber data for the subscriber, the identifier of the Home Subscriber Server and the identifier of the processing blade handling the subscriber.

20. The secondary subscriber register of claim 18, further comprising a restorer arranged for receiving a reset indication from the clustered subscriber register, the reset indication including the identifier of the clustered subscriber register and an identifier of a processing blade recovered after failure; and arranged for initiating a restoration procedure for all the subscribers in the secondary subscriber register with the received identifier of a processing blade.

21. A method of updating subscriber data between a clustered subscriber register and a secondary subscriber register, both holding subscriber data for subscribers in a mobile network, the subscriber data comprising subscription data and location data, the method comprising the steps of:
receiving at the clustered subscriber register location data for a subscriber from a serving node in the mobile network;
determining at a distributor of the clustered subscriber register a processing blade currently handling the subscriber among a plurality of processing blades, each processing blade handling a number of subscribers and including a storage and a processor;
processing at the processor included in the processing blade, a course of actions to be taken for the subscriber depending on the subscriber data; and
submitting from the clustered subscriber register towards the secondary subscriber register a subscriber identity for the subscriber, an identifier of the clustered subscriber register, and an identifier of the processing blade handling the subscriber at the clustered subscriber register.

22. The method of claim 21, further comprising a step of receiving an upgraded operation to process a course of actions for the subscriber, the upgraded operation including the subscriber identity for the subscriber and the identifier of the processing blade handling the subscriber.

23. The method of claim 21, wherein the step of submitting from the clustered subscriber register towards the secondary subscriber register a subscriber identity for the subscriber, an identifier of the clustered subscriber register, and an identifier of the processing blade includes a step of obtaining from the storage in the processing blade a set of subscriber data for the subscriber, and a step of submitting the set of subscriber data for the subscriber.

24. The method of claim 21, wherein the step of receiving location data for the subscriber takes place at a Visitor Location Register “VLR” holding subscriber data for subscribers roaming in a VLR area of the mobile network, the location data for the subscriber being submitted from a Mobile Switching Centre “MSC” currently serving the subscriber, and wherein the step of submitting takes place at the Visitor Location Register “VLR” towards a Home Location Register “HLR”, which holds subscriber data for subscribers of the mobile network, the submission including the subscriber identity for the subscriber, the identifier of the Visitor Location Register and the identifier of the processing blade handling the subscriber therein.

25. The method of claim 23, wherein the step of receiving location data for the subscriber takes place at a Home Location Register “HLR” holding subscriber data for subscribers of the mobile network, the location data for the subscriber being submitted from a Visitor Location Register “VLR”, which is serving the subscriber and holding subscriber data for subscribers roaming in a VLR area of the mobile network, the step of submitting taking place at the Home Location Register “HLR” towards a redundant Home Location Register “R-HLR”, which holds redundant subscriber data for subscribers of the mobile network, the submission including the subscriber identity and the set of subscriber data for the subscriber, the identifier of the Home Location Register and the identifier of the processing blade handling the subscriber therein.

26. The method of claim 25, further comprising a step of coordinating between the Home Location Register “HLR” and the redundant Home Location Register “R-HLR” a redundancy procedure for sending subscriber data for those subscribers handled in a processing blade identified by a given identifier.

27. The method of claim 25, further comprising a step of operating a state-transition machine on a processing blade basis to determine the status of the redundancy procedure on course for each processing blade.

28. The method of claim 23, wherein the step of receiving location data for the subscriber takes place at a Home Location Register “HLR” holding subscriber data for subscribers of the mobile network, the location data for the subscriber being submitted from a Visitor Location Register “VLR”, which is serving the subscriber and holding subscriber data for subscribers roaming in a VLR area of the mobile network, the step of submitting taking place at the Home Location Register “HLR” towards the Visitor Location Register, the submission including the subscriber identity and the set of subscriber data for the subscriber, the identifier of the Home Location Register and the identifier of the processing blade handling the subscriber therein.

29. The method of claim 23, wherein the step of receiving location data for the subscriber takes place at a Home Subscriber Server “HSS” holding subscriber data for subscribers of an IP Multimedia Subsystem “IMS” in the mobile network, the location data for the subscriber being submitted from a Serving Call Session Control Function server “S-CSCF”, which is assigned for serving the subscriber in the IMS, the step of submitting taking place at the Home Subscriber Server “HSS” towards said Serving Call Session Control Function server “S-CSCF, the submission including the subscriber identity and the set of subscriber data for the subscriber, the identifier of the Home Subscriber Server and the identifier of the processing blade handling the subscriber therein.

30. The method of claim 28, further comprising a step of submitting, after having recovered from a failure affecting a processing blade, a reset indication from the Home Location Register “HLR” to those Visitor Location Registers holding subscriber data for those subscribers handled by the recovered blade, the reset indication including the identifier of the Home Location Register and the identifier of the recovered processing blade.

31. The method of claim 29, further comprising a step of submitting, after having recovered from a failure affecting a processing blade, a reset indication from the Home Subscriber Server “HSS” towards those Serving Call Session Control Function servers “S-CSCF holding subscriber data for those subscribers handled by the recovered blade, the reset indication including the identifier of the Home Subscriber Server and the identifier of the recovered processing blade.

32.-33. (canceled)
